(19) United States
(12) Patent Application Publication
(10) Pub. No.: US 2007/0147781 A1
(43) Pub. Date: Jun. 28, 2007

(54) Information playback apparatus and operation key control method

(76) Inventor: Makoto Shibata, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/642,648

(22) Filed: Dec. 21, 2006

(30) Foreign Application Priority Data
Dec. 22, 2005 (JP) 2005-370749

(51) Int. Cl. H04N 7/00; H04N 5/91

(52) U.S. Cl. 386/95

(57) ABSTRACT

Operation keys are selectively invalidated according to the type of an information medium or recorded contents. The medium type of an information medium to be played back is discriminated in addition to detection as to whether or not the information medium to be played back includes information (ADV_OBJ file, etc.) unique to high-definition video information. If the discriminated information medium to be played back is an HD_DVD disc, or if the discriminated information medium to be played back includes an ADV_OBJ file or the like, operation keys (e.g., a repeat key) other than keys used in playback of the HD_DVD disc that records the high-definition video information are invalidated, and operation control is made in response to key operations other than the invalidated key operations.

### CROSS-REFERENCE TO RELATED APPLICATIONS

This application is based upon and claims the benefit of priority from Japanese Patent Application No. 2005-370749, filed Dec. 22, 2005, the entire contents of which are incorporated herein by reference.

### BACKGROUND

1. Field

One embodiment of the invention relates to an apparatus for playing back information from a plurality of types of information media (HD_DVD, DVD, CD, solid-state memory, HDD) and an operation key control method. In particular, one embodiment of the invention relates to a function of invalidating key inputs other than operation keys used in high definition DVD (HD_DVD) upon playing back the HD_DVD that allows complicated playback with more advanced functions in a playback apparatus which supports multi-playback modes of a next generation HD_DVD, current generation DVD, and the like.

2. Description of the Related Art

Nowadays, DVDs have widely prevailed as recording media of digital video information. In recent years, development of high definition DVD (HD_DVD) that can assure a higher resolution and more advanced functions have advanced, and an HD_DVD playback apparatus (player) is expected to be put into the market soon.

A DVD player also has a function of playing prior and existing optical media (CD, etc.), and tends to have complicated operation keys on a remote controller or the like compared to apparatuses dedicated to specific media. For this reason, unaccustomed users get lost in operations. An attempt to solve user's confusion about operations and improve operability has been conventionally made (see Jpn. Pat. Appln. KOKAI Publication No. 9-44984).

Jpn. Pat. Appln. KOKAI Publication No. 9-44984 discloses a disc player which can play back a plurality of types of discs. This player discriminates a disc type, and sets operators whose operations are invalid according to the disc discrimination result. By setting invalid commands according to the disc type, and by generating an alarm upon operation of an invalid command, user's confusion about operations can be resolved, thus improving operability.

Since invalid commands of operations are fixed based on the disc types, Jpn. Pat. Appln. KOKAI Publication No. 9-44984 cannot support a case wherein specific functions are suppressed by contents in discs with an identical format. For example, upon playing back a disc which records a conventional DVD-Video content (or standard content) and next-generation HD_DVD-Video content (or advanced content), if invalid commands are fixed based only on the discrimination result indicating the HD_DVD disc, invalid commands (invalid operation keys) cannot be further set according to objects to be played back from that disc.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are explanatory views showing the configurations of a standard content and advanced content;

FIGS. 2A, 2B, and 2C are explanatory views of discs of categories 1, 2, and 3;

FIG. 3 is an explanatory view showing a reference example of enhanced video objects (EVOBs) based on time map information (TMAPI);

FIG. 4 is an explanatory view showing a transition example of the playback states of a disc;

FIG. 5 is an explanatory view for explaining an example of the volume space of a disc according to the invention;

FIG. 6 is an explanatory view showing an example of directories and files of the disc according to the invention;

FIG. 7 is an explanatory view showing the configurations of management information (VMG) and video title sets (VTS) according to the invention;

FIG. 8 is a flowchart showing the startup sequence of a player model according to the invention;

FIG. 9 is an explanatory view showing the multiplex pack structure of a primary EVOB-TY2;

FIG. 10 is an explanatory view showing the ambient surrounding an advanced content player according to the invention;

FIG. 11 is an explanatory diagram showing a model of the advanced content player shown in FIG. 10;

FIG. 12 is an explanatory view showing the concept of recorded information on the disc according to the invention;

FIG. 13 is an explanatory view showing a configuration example of directories and files on the disc according to the invention;

FIG. 14 is an explanatory diagram showing the layout of the advanced content player according to the invention in more detail;

FIG. 15 is an explanatory diagram showing an example of a video mixing model shown in FIG. 14;

FIG. 16 is an explanatory view for explaining an example of a graphics hierarchy according to the invention;

FIG. 17 is a view for explaining the playback state of objects according to a playlist;

FIGS. 18A and 18B are views showing a display example of output video data on the screen of a display device;

FIG. 19 is a view showing an example of the configuration of a front panel of a player according to one embodiment of the invention;

FIG. 20 is an explanatory diagram showing an example of an audio mixing model according to the invention;

FIG. 21 is an explanatory diagram showing an example of a disc data supply model according to the invention;

FIG. 22 is an explanatory diagram showing an example of a network and persistent storage data supply model according to the invention;

FIG. 23 is an explanatory diagram showing an example of a data store model according to the invention;

FIG. 24 is an explanatory diagram showing an example of a user input handling model according to the invention;

FIG. 25 is a view for explaining the function of a playlist in the operation of the player according to the invention;

FIG. 26 is a view showing a mapping state of objects on a title timeline based on the playlist in the operation of the player according to the invention;

FIG. 27 is an explanatory view showing the reference relationship between a playlist file and other objects according to the invention;

FIG. 28 is an explanatory view showing the playback sequence according to the player of the invention;

FIG. 29 is an explanatory view showing a playback example of trick play according to the player of the invention;

FIG. 30 is an explanatory view showing an example of the content of an advanced application according to the invention;

FIG. 31 is a flowchart showing an example of the startup sequence for an advanced content in the operation of the player according to the invention;

FIG. 32 is a flowchart showing an example of the update sequence of advanced content playback in the operation of the player according to the invention;

FIG. 33 is a flowchart showing an example of the transition sequence between an advanced VTS and standard VTS in the operation of the player according to the invention;

FIG. 34 is a view for explaining the information contents recorded on a disc-shaped information storage medium according to one embodiment of the invention;

FIGS. 35A and 35B are views for explaining a configuration example of an advanced content;

FIG. 36 is a view for explaining a configuration example of a playlist;

FIG. 37 is a view for explaining an example of the allocation of presentation objects on a timeline;

FIG. 38 is a view for explaining an example of trick play (e.g., chapter jump, etc.) of presentation objects on a timeline;

FIG. 39 is a view for explaining a configuration example of a playlist when objects include angle information;

FIG. 40 is a view for explaining a configuration example of a playlist when objects include multi-stories;

FIG. 41 is a view for explaining a description example (when objects include angle information) of object mapping information in the playlist;

FIG. 42 is a view for explaining a description example (when objects include multi-stories) of object mapping information in the playlist;

FIG. 43 is a view for explaining examples (four examples in this case) of advanced object types;

FIG. 44 is a view for explaining an example of a remote controller used together with the player or the like shown in FIG. 19;

FIG. 45 is a block diagram showing an example of the internal structure of a player (a multi-disc player compliant to playback of HD_DVD-Video media and other media) operated by keys on the remote controller shown in FIG. 44;

FIG. 46 is a flowchart for explaining key control processing (HD_DVD identification processing, processing for invalidating key inputs other than keys used in HD_DVD, etc.) in the player shown in FIG. 45;

FIG. 47 is a table showing an example of file extensions and MIME types; and

FIG. 48 is a table showing an example of information data to be handled by the player.

### DETAILED DESCRIPTION

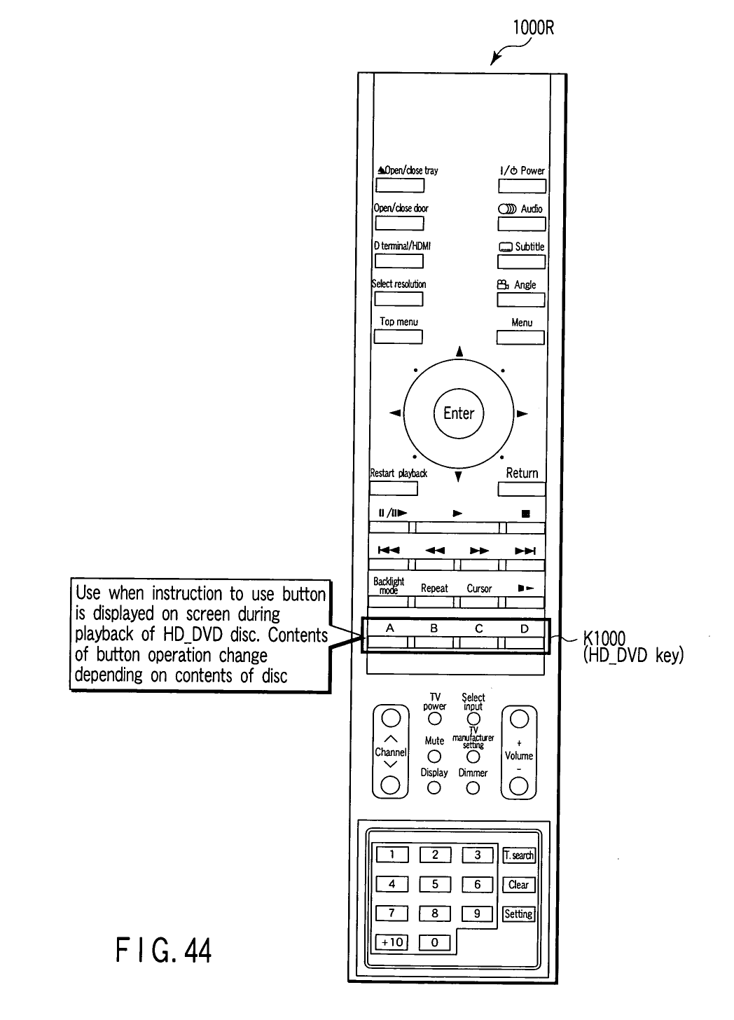

Various embodiments according to the invention will be described hereinafter with reference to the accompanying drawings. In general, according to one embodiment of the invention, user operation keys can be selectively invalidated according to not only the type of an information medium to be received, but also the recording contents. An operation key control method according to one embodiment of the invention is used in a method of playing back recorded information by a plurality of key operations from a plurality of types of information media including an information medium that records high-definition video information. In this operation key control method, the medium type (HD_DVD disc, DVD disc, CD, solid-state memory, HDD, Web, etc.) of an information medium to be played back is discriminated in addition to the detection as to whether or not the information medium to be played back includes information (ADV_OBJ file, etc.) unique to the high-definition video information (ST461). If the information medium discriminated as an object to be played back is the one which records the high-definition video information (HD_DVD disc), or if the information medium discriminated as an object to be played back includes the information (ADV_OBJ file, etc.) unique to the high-definition video information (YES in ST462), operation keys (e.g., a repeat key) other than those used in playback of the information medium (HD_DVD disc) that records the high-definition video information are invalidated (ST463), and operation control corresponding to key operations (ABCD key operations in FIG. 44, etc.) other than the invalidated key operations is made (ST467).

If an invalidated key operation is detected (YES in ST464), an alarm indicating that the key operation is invalid is visually and/or audibly produced (ST465).

Since keys used in playback of the high-definition video information medium (HD_DVD disc) are invalidated, user's confusion and anxiety (for example, the user mistakes the situation for a player trouble or medium defect because a player abnormally reacts or does not normally react in response to an operation key that he or she pressed without recognizing that key is an invalid key) can be cast aside.

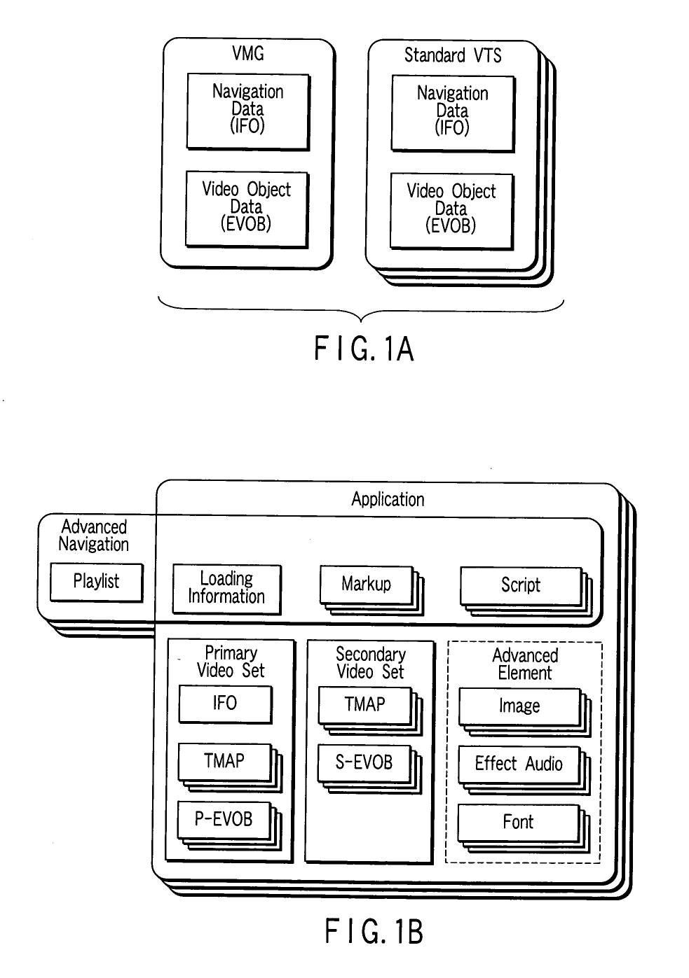

One embodiment of the invention will be described hereinafter with reference to the accompanying drawings. FIGS. 1A and 1B are block diagrams showing the basic concept of the invention. In an information storage medium, an information transfer medium, an information processing method and apparatus, an information playback method and apparatus, and an information recording method and apparatus according to the invention, new effective devices apply to the data format and its handling method. For this reason, data such as video data, audio data, other programs, and the like, especially, of resources can be re-used and the degree of freedom upon changing combinations of a plurality of resources is high. This will be apparent based on respective partial configurations, functions, and operations to be described hereinafter.

<Introduction>

The types of contents will be described.

The following description defines two types of contents. One content is a standard content, and the other content is an advanced content. The standard content is configured by navigation data and video objects on a disc, and is specified by expanding the DVD-Video standard Ver. 1.1.

On the other hand, the advanced content is configured by advanced navigation data such as a playlist, loading information, markup and script files, and the like, advanced data such as primary and secondary video sets and the like, and advanced element data (picture, audio, text, etc.).

At least one playlist file and primary video set needs to be allocated on a disc, and other data may be allocated on the disc or may be downloaded from a server.

<Standard Content> (See FIG. 1A)

The standard content is obtained by expanding the content specified by the DVD-Video standard Ver. 1.1 in association with especially high-resolution video, high-quality audio, and some new functions. The standard content is basically configured by one VMG space and one or a plurality of VTS spaces (to be referred to as “standard VTS” or simply “VTS” hereinafter).

<Advanced Content> (See FIG. 1B)

The advanced content realizes more advanced interactivity in addition to audio and video enhancements realized by the standard content. The advanced content is configured by advanced navigation data such as a playlist, loading information, markup and script files, and the like, advanced data such as primary and secondary video sets and the like, and advanced element data (picture, audio, text, etc.), and the advanced navigation data manages playback of the advanced data.

The playlist described in XML is located on the disc, and when the disc records the advanced content, the player executes this file first. This file provides the following information:
object mapping information: which is information in a title for presentation objects mapped on a title timeline;
a playback sequence: which is playback information for each title described based on the title timeline; and
configuration information: which is system configuration information such as data buffer alignment and the like.

According to the description of the playlist, the first application is executed with reference to primary and secondary video sets and the like if they are available. One application is configured by loading information, markups (including content, styling, and timing information), scripts, and advanced data. The first markup file, script file, and other resources which form the application are referred to within one loading information file. Based on the markup, playback of the advanced data such as primary and secondary video sets and the like, and advanced element data starts.

The structure of the primary video set is configured by one VTS space dedicated to this content. That is, this VTS includes neither navigation commands nor a multi-layered structure but includes TMAP information and the like. Also, this VTS can hold one main video stream, one sub video stream, eight main audio streams, and eight sub audio streams. This VTS is called “advanced VTS”.

The secondary audio set is used upon adding video data and audio data to the primary video set, and is also used upon adding audio data alone. However, this data can be played back only when the video and audio streams in the primary video set are not played back, and vice versa.

The secondary video set is recorded on the disc or is downloaded from a server as one or a plurality of files. This file is stored in a temporary cache file before playback if data is recorded on the disc and need be played back simultaneously with the primary video set. On the other hand, when the secondary video set exists on a Web site, the entire amount of data needs be stored in the temporary file cache (“downloading”) or this data need be partially contiguously stored in a streaming buffer. The stored data is simultaneously played back without any buffer overflow during downloading data from the server (“streaming”). FIG. 1B shows a configuration example of the advanced content.

Explanation of Advanced Video Title Set (Advanced VTS)

The advanced VTS (also called the primary video set) is used in a video title set for the advanced navigation data. That is, the following definitions are made in correspondence with the standard VTS.

1) More Advanced Enhancement of EVOB
one main video stream and one sub video stream
eight main audio streams and eight sub audio streams
32 sub-picture streams
one advanced stream

2) Integration of Enhanced EVOB Sets (EVOBS)
integration of both a menu EVOBS and title EVOBS

3) Elimination of Multi-Layered Structure
no title, no PGC (program chain), no PTT (part of title), and no cell
cancellation of navigation commands and UOP (user operation) control

4) Introduction of New Time Map Information (TMAP)
one TMAPI corresponds to one EVOB and is stored as one file.
some pieces of information in an NV_PCK are simplified.

Explanation of Interoperable VTS

An interoperable VTS is a video title set supported by the HD DVD-VR standard. This standard, i.e., the HD DVD-Video standard does not support any interoperable VTS, and the content writer cannot create any disc including an interoperable VTS. However, an HD DVD-Video player supports playback of the interoperable VTS.

<Disc Type>

This standard allows the three types of discs (category 1 disc, category 2 disc, and category 3 disc) defined as follows.

Explanation of Category 1 Disc

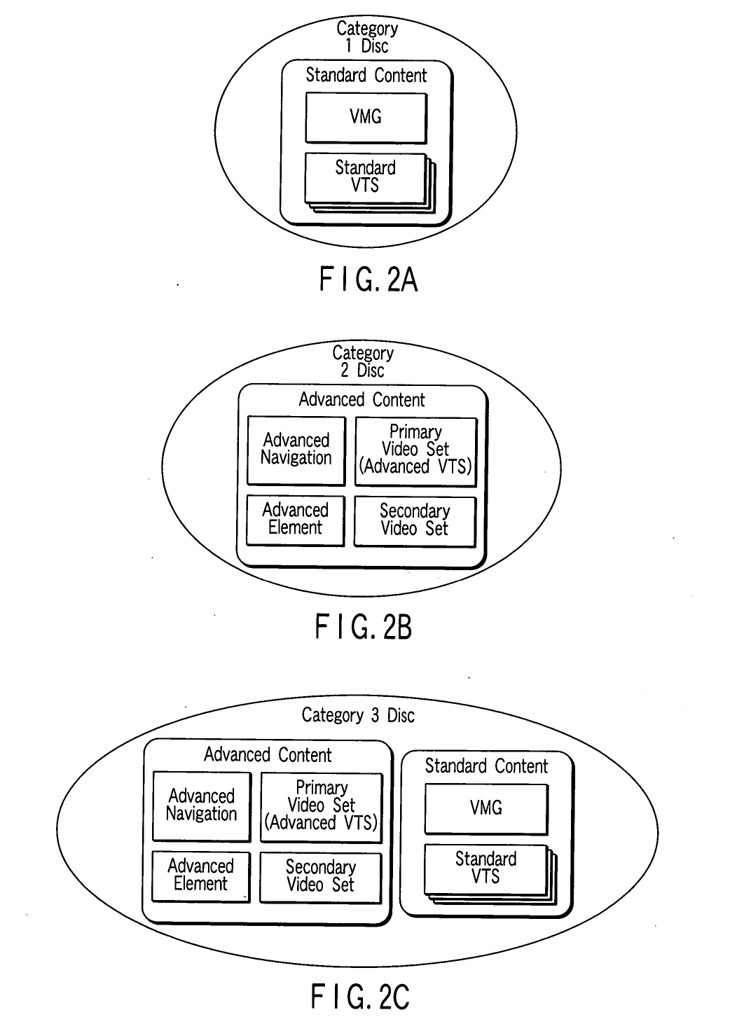

This disc includes only a standard content configured by one VMG and one or a plurality of standard VTSs. More specifically, this disc does not include any advanced VTS and advanced content. See FIG. 2A for a configuration example of this disc.

Explanation of Category 2 Disc

This disc includes only an advanced content configured by advanced navigation data, a primary video set (advanced VTS), a secondary video set, and advanced element data. That is, this disc does not include any standard content such as the VMG, standard VTS, and the like. See FIG. 2B for a configuration example of this disc.

Explanation of Category 3 Disc

This disc includes an advanced content configured by advanced navigation data, a primary video set (advanced VTS), a secondary video set, and advanced element data, and a standard content configured by one VMG (video manager) and one or a plurality of standard VTSs. However, this VMG includes neither FP_DOM nor VMGM_DOM. See FIG. 2C for a configuration example of this disc.

This disc includes the standard content. However, this disc basically follows the rules of the category 2 disc, and includes transition from an advanced content playback state to a standard content playback state, and vice versa.

Explanation about Use of Standard Content by Advanced Content

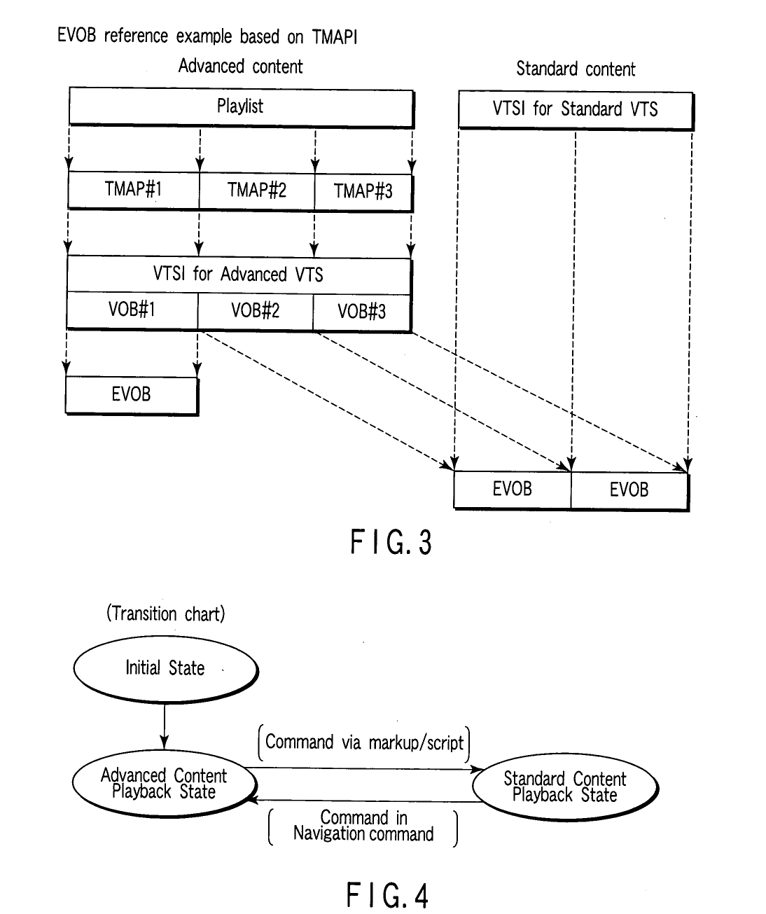

The standard content can be used by the advanced content. VTSI (video title set information) of the advanced VTS can refer to an EVOB, which can be referred to by VTSI of the standard VTS using TMAP information. The EVOB can include HLI (highlight information, PCI (program control information), and the like, which are not supported by the advanced content. Upon playback of such EVOB, for example, the HLI and PCI are ignored in the advanced content. FIG. 3 shows the state wherein the standard content is used, as described above.

Explanation of Transition Between Standard Content and Advanced Content Playback States

As for the category 3 disc, the advanced content and standard content are respectively independently played back. FIG. 4 is a view showing transition between the playback states of this disc. The advanced navigation data (i.e., playlist file) is interpreted in “Initial State”, and the first application in the advanced content is executed in “Advanced Content Playback State”. In this case, the player executes a designated command such as CallStandardContentPlayer or the like with an argument that designates the playback position via a script during playback of the advanced content, thus playing back the standard content.

During playback of the standard content, the player executes a designated command such as a navigation command CallAdvancedContentPlayer or the like, thus returning to the advanced content playback state.

In the advanced content playback state, the advanced content can load and system parameters can be (from SPRM(1) to SPRM(10)). During transition, the SPRM values are contiguously held. For example, in the advanced content playback state, the advanced content sets SPRM values for audio streams in accordance with the current audio playback state for appropriate playback of audio streams in the standard content playback state after transition. Even when the user in the standard content playback state changes audio streams, the advanced content loads the SPRM values for audio streams after transition, and changes the audio playback state in the advanced content playback state.

<Logical Data Structure>

The disc structure is configured by one volume space, one video manager (VMG), one video title set (VTS), one enhanced video object set (EVOBS), and the advanced content to be described below.

<Structure of Volume Space>

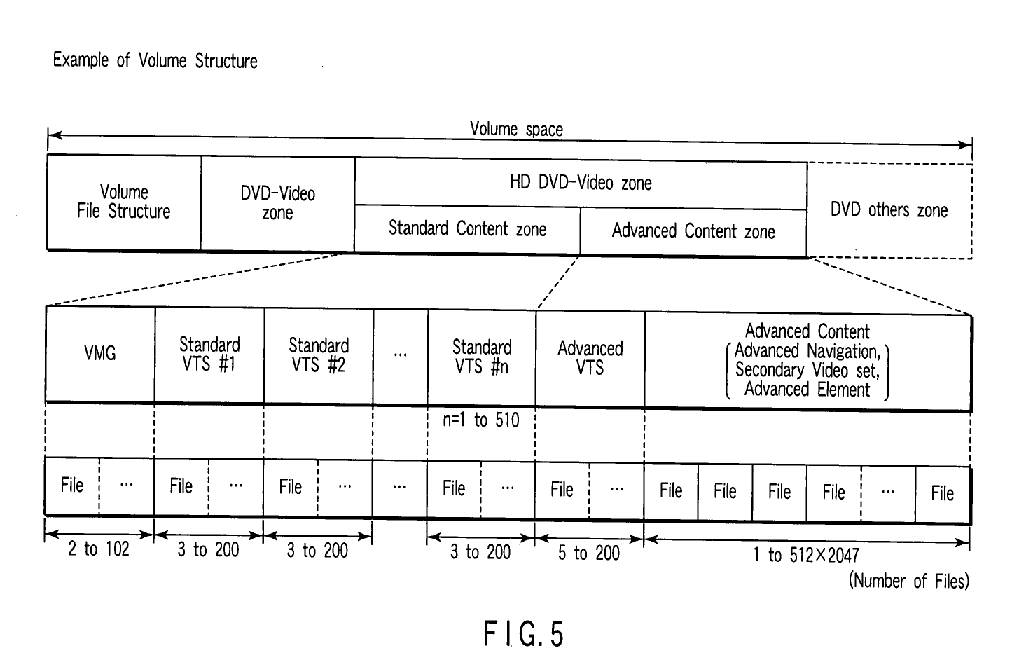

As shown in FIG. 5, the volume space of the HD DVD-Video disc is configured by the following elements:

1) a volume and file structure which is assigned for a UDF structure;

2) a single “HD DVD-Video zone” which is often assigned for the data structure of the DVD-Video format;

3) a single “HD DVD-Video zone” which is often assigned for the data structure of the DVD-Video format (this zone is configured by a “standard content zone” and “advanced content zone”); and

4) a “DVD others zone” which is often used for applications which are not those for DVD-Video and HD DVD-Video.

The following rules apply to the “HD DVD-Video zone”.

1) The “HD DVD-Video zone” in the category 1 disc is configured by one “standard content zone”. The “HD DVD-Video zone” in the category 2 disc is configured by one “advanced content zone”. The “HD DVD-Video zone” in the category 3 disc is configured by both one “standard content zone” and one “advanced content zone”.

2) The “standard content zone” is configured by a single video manager (VMG) and at least one to a maximum of 510 video title sets (VTSs) in the category 1 disc. The category 2 disc does not include any “standard content zone”. In the category 3 disc, the “standard content zone” is configured by at least one to a maximum of 510 video title sets (VTSs).

3) The VMG is assigned to the head of the “HD DVD-Video zone” if it is available, i.e., in case of the category 1 disc.

4) The VMG is configured by at least two to a maximum of 102 files.

5) Each VTS (except for the advanced VTS) is configured by at least three to a maximum of 200 files.

6) The “advanced content zone” is configured by files supported by the advanced content zone having the advanced VTS. The maximum number of files for the advanced content zone is 512×2047 (under an ADV_OBJ directory).

7) The advanced VTS is configured by at least five to a maximum of 200 files.

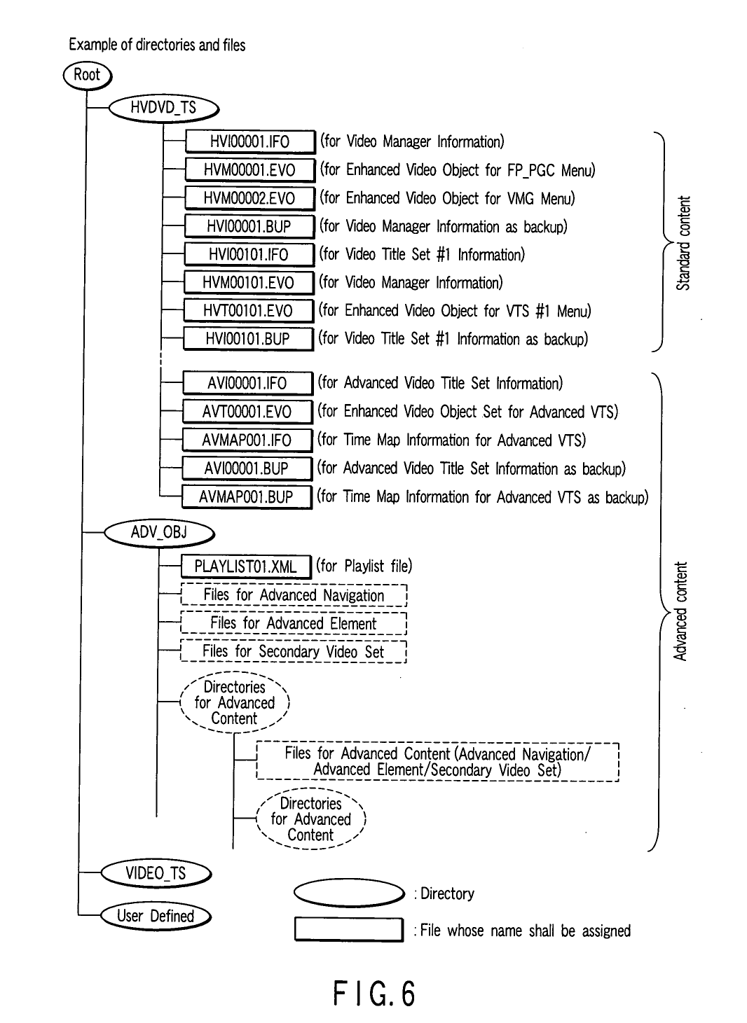

Note: a description of the DVD-Video zone will be omitted since it is known to those who are skilled in the art.

<Rules Associated with Directories and Files (FIG. 6)>

The prerequisites for files and directories associated with the HD DVD-Video disc will be described below.

HVDVD_TS Directory

An “HVDVD_TS” directory is allocated immediately under the root directory. All files associated with one VMG, one or a plurality of standard video sets, and one advanced VTS (primary video set) are recorded under this directory.

Video Manager (VMG)

One video manager information (VMGI), one enhanced video object for first play program chain menu (FP_PGCM_EVOB), and one video manager information as backup (VMGI_BUP) are recorded under the HVDVD_TS directory as configuration files, respectively. When the size of one enhanced video object set for video manager menu (VMGM_EVOBS) is equal to or larger than 1 GB (=2³⁰ bytes), it has to be divided to have a maximum number of files=98 under the HVDVD_TS directory. As for these files of one VMGM_EVOBS, all files should be assigned contiguously.

Standard Video Title Set (Standard VTS)

One video title set information (VTSI) and one video title set information as backup (VTSI_BUP) are recorded under the HVDVD_TS directory as configuration files, respectively. When the size of an enhanced video object set for video title set menu (VTSM_EVOBS) and an enhanced video object set for title (VTSTT_EVOBS) is equal to or larger than 1 GB (=2³⁰ bytes), they have to be divided into a maximum of 99 files so that each file size becomes smaller than 1 GB. These files are configuration files under the HVDVD_TS directory. As for these files of one VTSM_EVOBS and one VTSTT_EVOBS, all files should be assigned contiguously.

Advanced Video Title Set (Advanced VTS)

One video title set information (VTSI) and one video title set information as backup (VTSI_BUP) can be recorded under the HVDVD_TS directory as configuration files, respectively. One video title set time map information (VTS_TMAP) and one video title set time map information as backup (VTS_TMAP_BUP) can be respectively configured by a maximum of 99 files under the HVDVD_TS directory. If the size of an enhanced video object set for title (VTSTT_EVOBS) is equal to or larger than 1 GB (=2³⁰ bytes), it has to be divided into a maximum of 99 files so that each file size becomes smaller than 1 GB. These files are configuration files under the HVDVD_TS directory. As for these files in one VTSTT_EVOBS, all files should be assigned contiguously.

The following rules apply to the file names and directory names under the HVDVD_TS directory.

1) Directory Name

The permanent directory name of DVD-Video is “HVDVD_TS”.

2) File Names for Video Manager (VMG)

The permanent file name of the video manager information is “HVI00001.IFO”,

the permanent file name of the enhanced video object for an FP_PGC menu is “HVM00001.EVO”,

the file name of the enhanced video object set for VMG menu is “HVM000%%.EVO”,

the permanent file name of the video manager information as backup is “HVI00001.BUP”, and
“%%” is contiguously assigned to respective enhanced video object sets for VMG menu in turn from “02” to “99” in ascending order.

3) File Names for Standard Video Set (Standard VTS)

The file name of the video title set information is “HVI@@@01.IFO”,

the file name of the enhanced video object set for VTS menu is “HVM@@@##.EVO”,

the file name of the enhanced video object set for title is “HVT@@@##.EVO”,

the file name of the video title set information as backup is “HVI@@@01.BUP”,
“@@@” is three characters assigned to files of video title set numbers, and ranges from “001” to “511”, and
“##” is contiguously assigned to respective enhanced video object sets for VTS menu or respective enhanced video object sets for title in turn from “01” to “99” in ascending order.

4) File Names of Advanced Video Title Set (Advanced VTS)

The file name of the video title set information is “AVI00001.IFO”,

the file name of the enhanced video object set for title is “AVT000&&.EVO”,

the file name of the time map information is “AVMAP0$$.IFO”,

the file name of video title set information as backup is “AVI00001.BUP”,

the file name of the time map information as backup is “AVMAP0$$.BUP”,
“&&” is contiguously assigned to respective enhanced video object sets for title in turn from “01” to “99” in ascending order, and
“$$” is contiguously assigned to respective pieces of time map information in turn from “01” to “99” in ascending order.

ADV_OBJ Directory

An “ADV_OBJ” directory is allocated immediately under the root directory. All playlist files are recorded immediately under this directory. All files of the advanced navigation data, advanced element data, and secondary video set can be recorded immediately under this directory.

Playlist

Each playlist file can be recorded immediately under the “ADV_OBJ” directory to have a file name “PLAYLIST %%.XML”. “%%” is contiguously assigned in turn from “00” to “99” in ascending order. A playlist file with a maximum number is processed first (when the disc is loaded).

Directories for Advanced Content

“Directories for advanced content” can be allocated only under the “ADV_OBJ” directory. All files of the advanced navigation data, advanced element data, and secondary video set can be recorded under this directory. This directory name is configured by d-characters and d1-characters. The total number of “ADV_OBJ” subdirectories (except for the “ADV_OBJ” directory) is less than 512. The depth of directory layers is 8 or less.

Files for Advanced Content

The total number of files under the “ADV_OBJ” directory is limited to 512×2047, and the total number of files recorded in each directory is less than 2048. This file name is configured by d-characters or d1-characters, and includes a body, “.”, and extension. FIG. 6 shows an example of the structure of the directories and files mentioned above.

<Structure of Video Manager (VMG)>

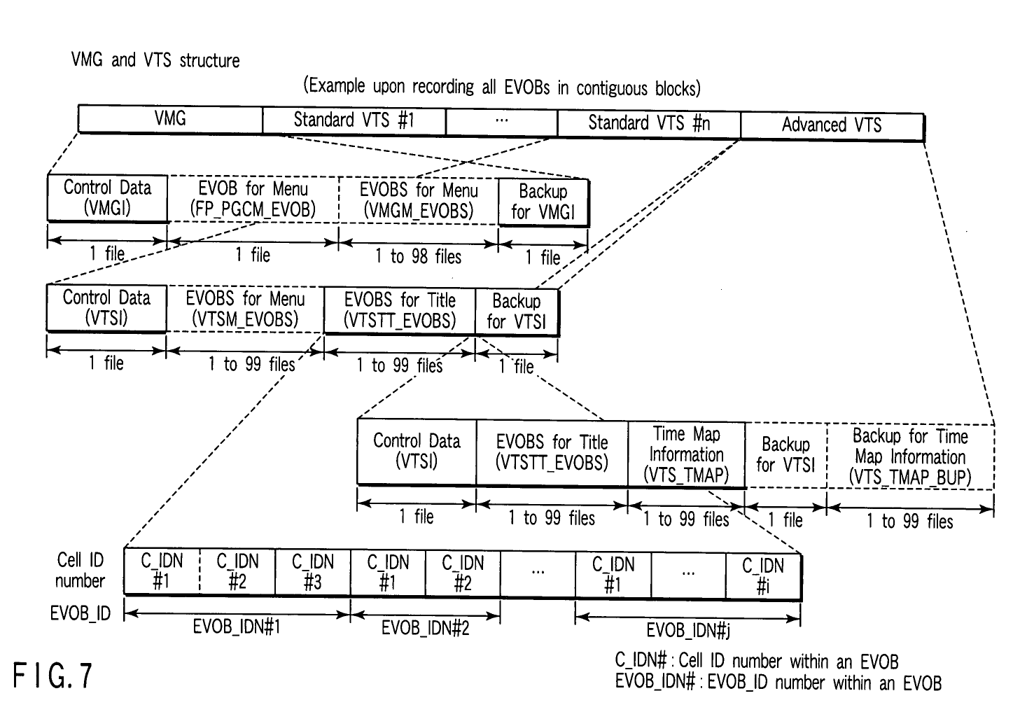

The VMG is a table of contents of all video title sets recorded in the “HD DVD-Video zone”. As shown in FIG. 7, the VMG is configured by control data called VMGI (video manager information), an enhanced video object for first play PGC menu (FP_PGCM_EVOB), an enhanced video object set for VMG menu (VMGM_EVOBS), and a backup of control data (VMGI_BUP). The control data is static information used to play back each title, and provides information that supports user operations. The FP_PGCM_EVOB is an enhanced video object (EVOB) used to select a menu language. The VMGM_EVOBS is a set of enhanced video objects (EVOBs) used in a menu for supporting volume access.

The following rules apply to the video manager (VMG).

1) Each of the control data (VMGI) and the backup of control data (VMGI_BUP) is a single file less than 1 GB.

2) The EVOB for FP_PGC menu (FP_PGCM_EVOB) is a single file less than 1 GB. The EVOBS for VMG menu (VMGM_EVOBS) is divided into files each having a size less than 1 GB, and the maximum number of files is (98).

3) The VMGI, FP_PGCM_EVOB (if it is available), VMGM_EVOBS (if it is available), and VMGI_BUP are assigned in this order.

4) The VMGI and VMGI_BUP do not have to be recorded in a single ECC block.

5) Files which form the VMGM_EVOBS are contiguously assigned.

6) The contents of the VMGI_BUP are exactly the same as those of the VMGI. Therefore, when relative address information in the VMGI_BUP points to a location outside the VMGI_BUP, that relative address is considered as that of the VMGI.

7) The boundaries between the neighboring VMGI, FP_PGCM_EVOB (if it is available), VMGM_EVOBS (if it is available), and VMGI_BUP may have gaps.

8) In the VMGM_EVOBS (if it is available), respective EVOBs are contiguously assigned.

9) The VMGI and VMGI_BUP are recorded in logically contiguous areas specified by continuous LSNs.

Note: this standard is applicable to DVD-R for General, DVD-RAM, DVD-RW, and DVD-RAM, but respective media should comply with the rules of data allocation described in Part 2 (file system specification).

<Structure of Standard Video Title Set (Standard VTS)>

The VTS is a set of titles. As shown in FIG. 7, each VTS is configured by control data called VTSI (video title set information), an enhanced video object set for VTS menu (VTSM_EVOBS), an enhanced video object set for title (VTSTT_EVOBS), and backup control data (VTSI_BUP).

The following rules apply to the video title set (VTS).

1) Each of the control data (VTSI) and the backup of control data (VTSI_BUP) is a single file less than 1 GB.

2) Each of the EVOBS for VTS menu (VTSM_EVOBS) and EVOBS in one VTS (VTSTT_EVOBS) is divided into files each having a file size less than 1 GB, and the maximum number of files is (99).

3) The VTSI, VTSM_EVOBS (if it is available), VTSTT_EVOBS, and VTSI_BUP are assigned in this order.

4) The VTSI and VTSI_BUP are not recorded in a single ECC block.

5) Files which form the VTSM_EVOBS are contiguously assigned, and those which form the VTSTT_EVOBS are also contiguously assigned.

6) The contents of the VTSI_BUP are exactly the same as those of the VTSI. Therefore, when relative address information in the VTSI_BUP points to a location outside the VTSI_BUP, that relative address is considered as that of the VTSI.

7) VTS numbers are serial numbers which are assigned to VTSs in the volume. The VTS number ranges from “1” to “511”, and is assigned in the order that the VTSs are stored on the disc (from a minimum LBN at the head of VTSI of each VTS).

8) As for each VTS, the boundaries between the neighboring VTSI, VTSM_EVOBS (if it is available), VTSTT_EVOBS, and VTSI_BUP may have gaps.

9) In each VTSM_EVOBS (if it is available), respective EVOBs are contiguously assigned.

10) In each VTSTT_EVOBS, respective EVOBs are contiguously assigned.

11) The VTSI and VTSI_BUP are recorded in logically contiguous areas specified by continuous LSNs.

Note: this standard is applicable to DVD-R for General, DVD-RAM, DVD-RW, and DVD-RAM, but respective media should comply with the rules of data allocation described in Part 2 (file system specification). Details of allocation will be described in Part 2 (file system standard) for respective media.

<Structure of Advanced Video Title Set (Advanced VTS)>

This VTS is configured by only one title. As shown in FIG. 7, this VTS is configured by control data called VTSI (see 6.3.1 video title set information), an enhanced video object set for title (VTSTT_EVOBS), video title set time map information (VTS_TMAP), backup control data (VTSI_BUP), and a backup of video title set time map information (VTS_TMAP_BUP).

The following rules apply to the video title set (VTS).

1) Each of the control data (VTSI) and the backup of control data (VTSI_BUP) (if it is available) is a single file less than 1 GB.

2) The EVOBS for title (VTSTT_EVOBS) in one VTS is divided into files each having a file size less than 1 GB, and the maximum number of files is (99).

3) Each of one video title set time map information (VTS_TMAP) and its backup (VTS_TMAP_BUP) (if it is available) is divided into files each having a file size less than 1 GB, and the maximum number of files is (99).

4) The VTSI and VTSI_BUP (if it is available) are not recorded in a single ECC block.

5) The VTS_TMAP and VTS_TMAP_BUP (if it is available) are not recorded in a single ECC block.

6) Files which form the VTSTT_EVOBS are contiguously assigned.

7) The contents of the VTSI_BUP (if it is available) are exactly the same as those of the VTSI. Therefore, when relative address information in the VTSI_BUP points to a location outside the VTSI_BUP, that relative address is considered as that of the VTSI.

8) In each VTSTT_EVOBS, respective EVOBs are contiguously assigned.

Note: this standard is applicable to DVD-R for General, DVD-RAM, DVD-RW, and DVD-RAM, but respective media should comply with the rules of data allocation described in Part 2 (file system specification). Details of allocation will be described in Part 2 (file system standard) for respective media.

<Structure of Enhanced Video Object Set (EVOBS)>

The EVOBS is a set of enhanced video objects each of which is configured by video, audio, sub-picture, and the like (FIG. 7).

The following rules apply to the EVOBS.

1) In one EVOBS, EVOBs are recorded in contiguous blocks and interleaved blocks. See 3.3.12.1 allocation of presentation data for the contiguous blocks and interleaved blocks.

In case of the VMG and standard VTS,

2) One EVOBS is configured by one or a plurality of EVOBs. EVOB_ID numbers are assigned from an EVOB having a smallest LSN in the EVOBS to start from one (1) in ascending order.

3) One EVOB is configured by one or a plurality of cells. C_ID numbers are assigned from an EVOB having a smallest LSN in the EVOBS to start from one (1) in ascending order.

4) The cells in the EVOBS can be discriminated by the EVOB_ID numbers and C_ID numbers.

3.3.7 Relationship Between Logical Structure and Physical Structure

As for the VMG and standard VTS, the following rules apply to cells.

1) One cell is assigned to a single layer.

<MIME Type>

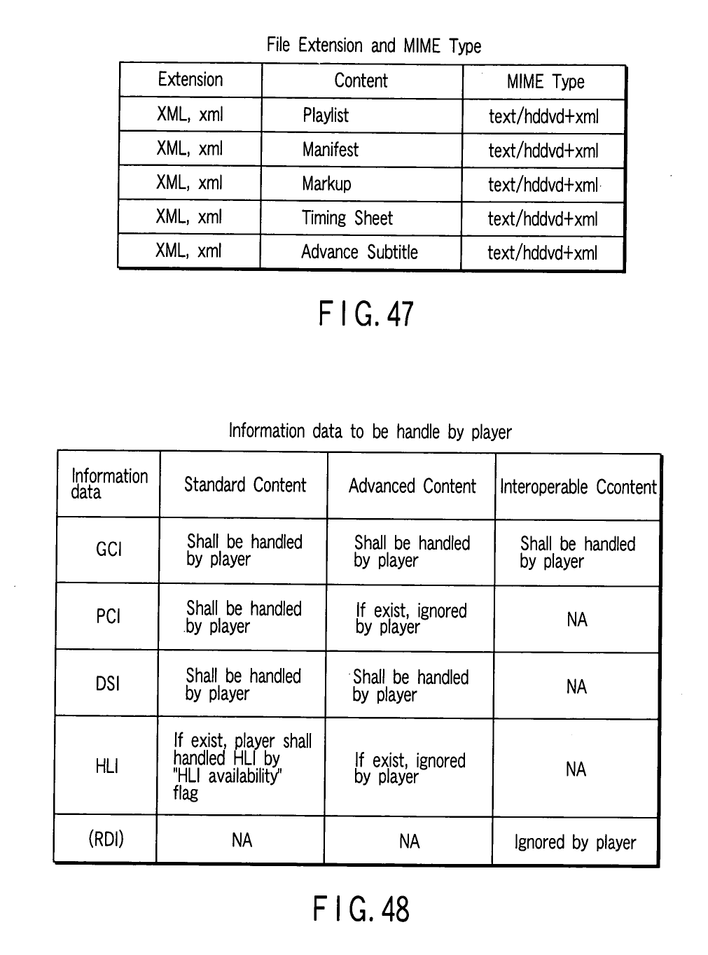

FIG. 47 defines the extension names and MIME types of respective resources in this standard. FIG. 47 shows an example of the file extensions and MIME types.

“System Model”

<Overall Startup Sequence>

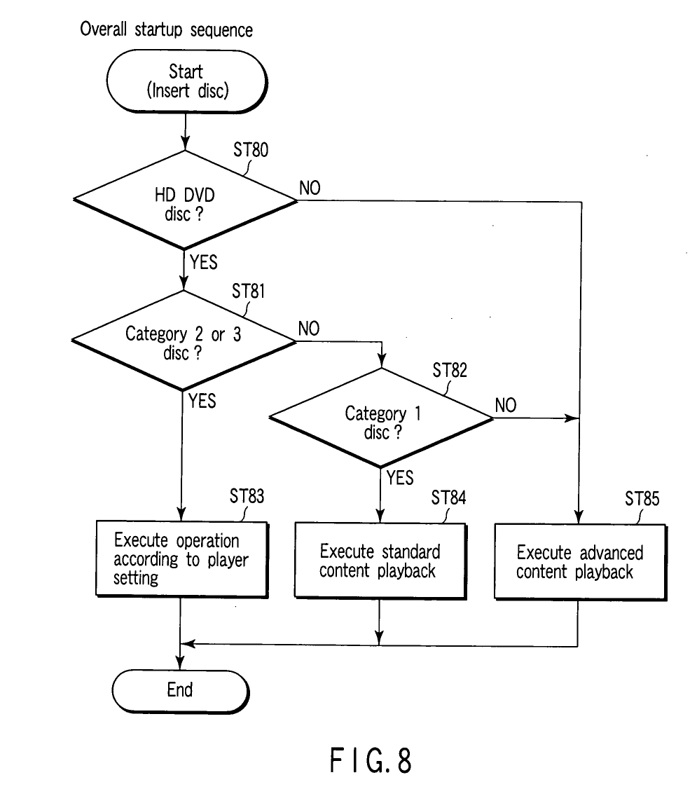

FIG. 8 is a flowchart showing the startup sequence of the HD DVD player. After a disc is inserted, the player confirms if “ADV_OBJ” and “playlist.xml (Tentative)” exist under the “ADV_OBJ” directory. If “playlist.xml (Tentative)” exists (YES in ST80), the HD DVD player determines that the inserted disc is a category 2 or 3 disc. If “playlist.xml (Tentative)” does not exist (NO in ST80), the HD DVD player checks the disc VMG_ID of VMGI. If this disc belongs to category 1 (NO in ST81, YES in ST82), the disc VMG_ID is “HD DVD_VMG200”. Byte positions b0 to b15 of a VMG_CAT indicate only the standard category. If this disc does not belong to any category of HD DVD (NO in ST82), the subsequent process depends on each player (ST83). The playback procedures (ST84, ST85) of the advanced content and standard content are different.

<Information Data to be Handled by Player>

Of respective contents (standard content, advanced content, or interoperable content), a P-EVOB (primary enhanced video object) to be handled by the player includes some to-be-used information data.

These to-be-used information data include GCI (general control information), PCI (presentation control information), and DSI (data search information), and these data are stored in a navigation pack (NV_PCK). Also, HLI (highlight information) is stored in a plurality of HLI packs. FIG. 48 shows the information data to be handled by the player. “NA” means “Not Applicable”. Note that RDI (real time data information) is written in the DVD standard of high-quality writable discs (Part 3, Video Recording Specifications).

<System Model for Advanced Content>

<Data Type of Advanced Content>

Advanced Navigation

Advanced navigation indicates the data type of navigation data for the advanced content configured by the following type files:
playlist;
loading information;
markup;
content;
styling;
timing; and
script.

<Advanced Data>

Advanced data indicate the data types of presentation data for the advanced contents. The advanced data can be classified into the following four types:
primary video set;
secondary video set;
advanced element data; and
other.

<Primary Video Set>

A primary video set is a set of data for primary video. The data structure of the primary video set matches that of the advanced VTS, and is configured by navigation data (VTSI, TMAP, etc.) and presentation data (P-EVOB-TY2, etc.). The primary video set is stored on the disc. The primary video set can include various presentation data. Possible presentation stream types include main video, main audio, sub video, sub audio, and sub-picture. The HD DVD player can simultaneously play back sub video and audio streams in addition to primary video and audio streams. However, the player cannot play back sub video and sub audio streams of a secondary video set during playback of sub video and sub audio streams.

<Secondary Video Set>

A secondary video set is a set of data for network streaming and a content pre-downloaded on a file cache. The data structure of the secondary video set corresponds to a simplified structure of the advanced VTS, and is configured by TMAP and presentation data (S-EVOB). The secondary video set can include sub video, sub audio, substitute audio, and complementary subtitle. The substitute audio stream is used as an alternative audio stream that replaces the main audio stream in the primary video set. The complementary subtitle stream is used as an alternative subtitle stream that replaces the sub-picture stream in the primary video set. The data format of the complementary subtitle stream is an advanced subtitle.

<Primary Enhanced Video Object Type 2 (P-EVOB-TY2)>

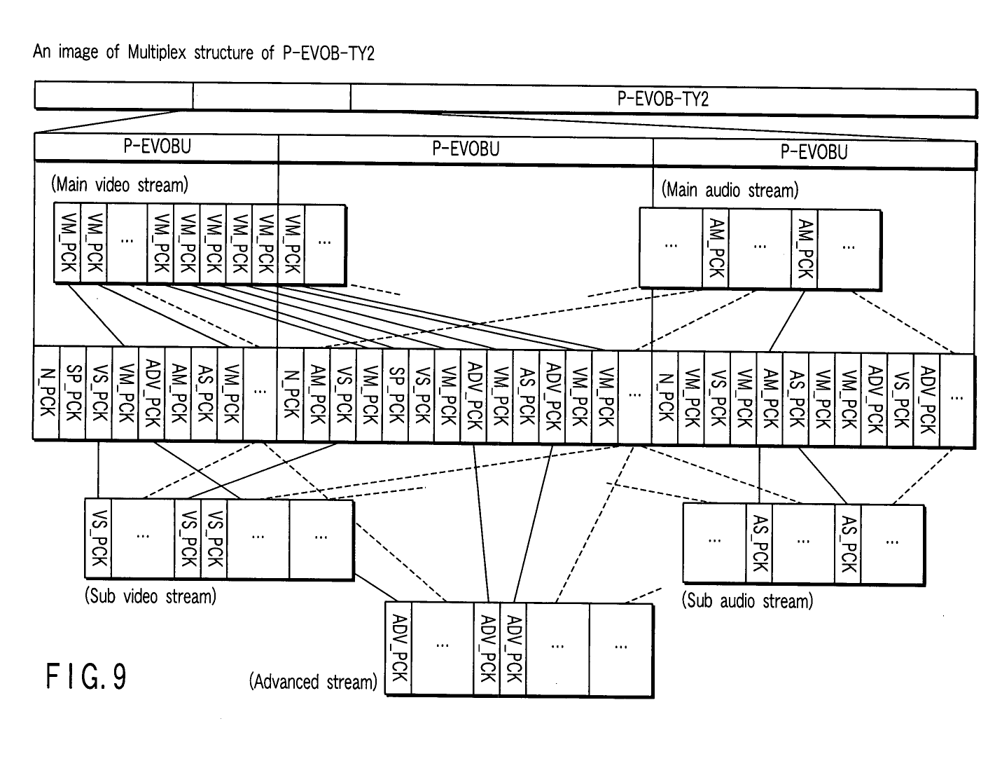

A primary enhanced video object type 2 (P-EVOB-TY2) is a data stream which transports presentation data of the primary video set, as shown in FIG. 9. The primary enhanced video object type 2 is compatible with a program stream specified in “system part of the MPEG-2 standard (ISO/IEC 138181-1)”. The presentation data types of the primary video set include main video, main audio, sub video, sub audio, and sub-picture. The advanced stream is further multiplexed into the P-EVOB-TY2. Possible pack types in the P-EVOB-TY2 are:
navigation pack (N_PCK);
main video pack (VM_PCK);
main audio pack (AM_PCK);
sub video pack (VS_PCK);
sub audio pack (AS_PCK);
sub-picture pack (SP_PCK); and
advanced stream pack (ADV_PCK).

A time map (TMAP) for the primary enhanced video object type 2 includes an entry point for each primary enhanced video object unit (P-EVOBU).

An access unit for the primary video set is based on that of main video and the conventional video object (VOB) structure. Offset information for sub video and sub audio is given by sync information (SYNCI), main audio, and sub-picture.

The advanced stream is used to supply various kinds of advanced content files to the file cache without interrupting playback of the primary video set. A demultiplexing module in a primary video player distributes advanced stream packs (ADV_PCK) to a file cache manager in a navigation engine.

FIG. 9 shows an image of the multiplex structure of the P-EVOB-TY2.

The following models are associated with the P-EVOB-TY2:
an input buffer model for the primary enhanced video object type 2 (P-EVOB-TY2);
a decoding model for the primary enhanced video object type 2 (P-EVOB-TY2); and
an enhanced system target decoder (E-STD) model for the primary enhanced video object type 2.

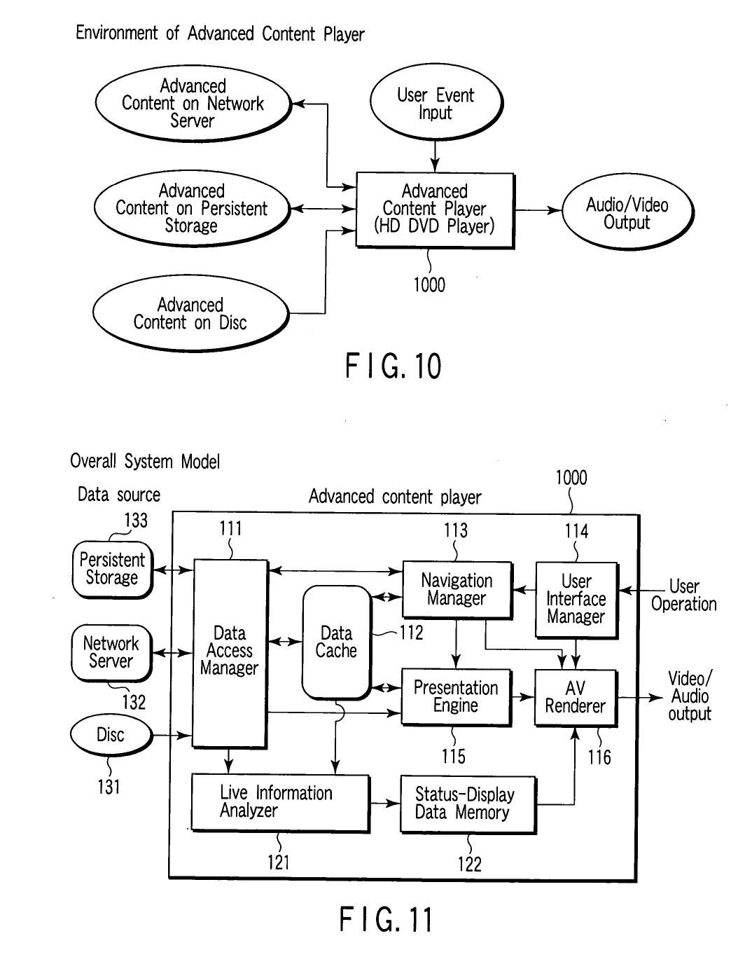

FIG. 10 shows an enhanced system target decoder model for the P-EVOB-TY2. Packets input to a de-multiplex via a track buffer are demultiplexed according to their types, and are supplied to a main video buffer, sub video buffer, sub picture buffer, PCI buffer, main audio buffer, and sub audio buffer. The respective buffer outputs can be decoded by corresponding decoders.

<Environment for Advanced Content>

FIG. 10 shows the playback environment of an advanced content player. The advanced content player is a logical player for the advanced content.

Data sources of the advanced content include a disc, network server, and persistent storage. Playback of the advanced content requires a category 2 or 3 disc. The advanced content can be stored on the disc irrespective of the data types. The persistent storage and network server can store the advanced content except for the primary video set irrespective of the data type.

A user event input occurs by a user input device such as a remote controller, front panel, or the like of the HD DVD player. The advanced content player serves to input a user event to the advanced content and to generate a correct response. The audio and video outputs are respectively supplied to loudspeakers and a display device.

<Overall System Model>

The advanced content player is a logic player for the advanced content. FIG. 11 shows a simplified advanced content player. This player has six logic function modules, i.e., data access manager 111, data cache 112, navigation manager 113, user interface manager 114, presentation engine 115, and AV renderer 116 as basic components.

Furthermore, the player has live information analyzer 121 and status display data memory 122 as characteristic features of the invention.

Data access manager 111 serves to exchange various kinds of data between the data sources and internal modules of the advanced content player.

Data cache 112 is a temporary data storage of the advanced content for playback.

Navigation manager 113 serves to control every function modules of the advanced content player according to a description in the advanced navigation data.

User interface manager 114 serves to control user interface devices such as the remote controller, front panel, and the like of the HD DVD player, and notifies navigation manger 113 of the user input event.

Presentation engine 115 serves to play back presentation materials such as the advanced element data, primary video set, secondary video set, and the like.

AV renderer 116 serves to mix video and audio inputs from other modules and to output the mixed input to external devices such as loudspeakers, a display, and the like.

<Data Source>

The types of data sources used in playback of the advanced content will be described below.

<Disc>

Disc 131 is an indispensable data source for advanced content playback. The HD DVD player comprises an HD DVD disc drive. Authoring of the advanced content is needed to allow playback even when the available data sources are only the disc and an indispensable persistent storage.

<Network Server>

Network server 132 is an optional data source for advanced content playback, but the HD DVD player should have network access capability. The network server is normally controlled by the contents provider of the current disc. The network server is normally located on the Internet.

<Persistent Storage>

Persistent storage 133 is divided into two categories.

One category is called a “fixed persistent storage”. This is an indispensable persistent storage attached to the HD DVD player. As a representative type of this storage, a flash memory is known. The minimum capacity of the fixed persistent storage is 64 MB.

The other category is an option, and is called an “auxiliary persistent storage”. The auxiliary persistent storage may be a removable storage such as a USB memory or HDD, a memory card, or the like. One of possible auxiliary persistent storages is an NAS. This standard does not specify any device implementation. These storages should follow an API model for the persistent storage.

<About Data Structure on Disc>

<Data Type on Disc>

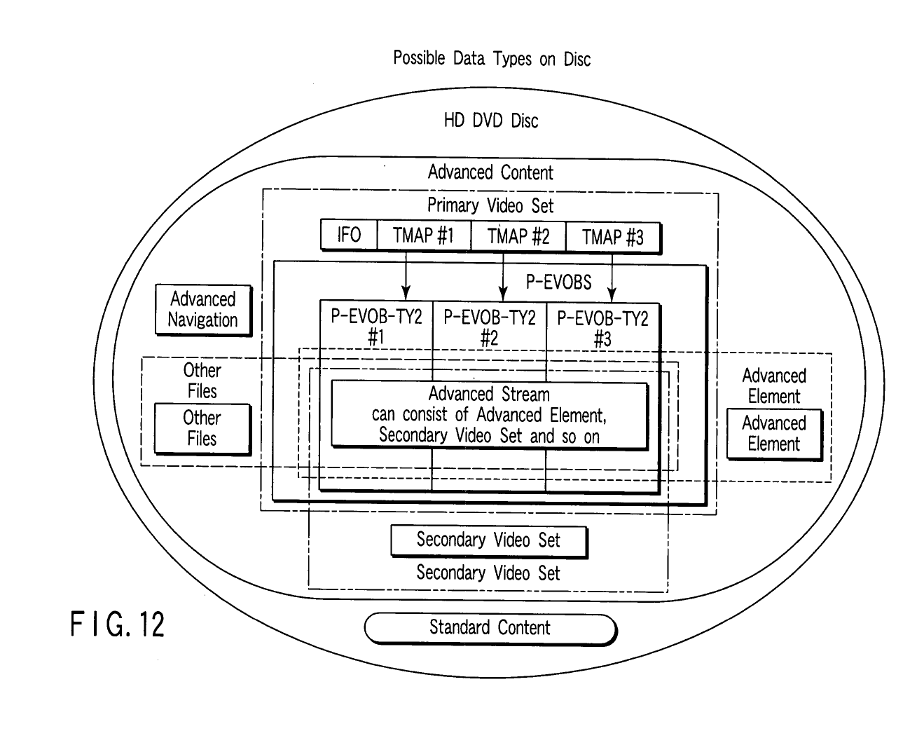

FIG. 12 shows data types which can be stored on the HD DVD disc. The disc can store both the advanced content and standard content. Possible data types of the advanced content include advanced navigation, advanced element, primary video set, secondary video set, and the like.

FIG. 12 shows the possible data types on the disc. An advanced stream is a data format which archives some types of advanced content files except for the primary video set. The advanced stream is multiplexed into the primary enhanced video object type 2 (P-EVOB-TY2), and is demultiplexed together with P-EVOB-TY2 data supplied to the primary video player. Identical files which are archived in the advanced stream and are indispensable for advanced content playback are stored as files. These copied files guarantee playback of the advanced content. This is because supply of the advanced stream is not completed when playback of the primary video set jumps. In this case, to-be-used files are directly loaded from the disc onto the data cache before playback restarts from the designated jump position.

Advanced Navigation: Advanced navigation is a file. The advanced navigation file is loaded during the startup sequence, and is interpreted for advanced content playback.

Advanced Element: Advanced element data is a file that can also be archived into the advanced stream, which is multiplexed into the P-EVOB-TY2.

Primary Video Set: Only one primary video set is recorded on the disc.

Secondary Video Set: A secondary video set is a file that can also be archived into the advanced stream, which is multiplexed into the P-EVOB-TY2.

Other Files: Other files may exist depending on the advanced content.

<Configuration of Directory and File>

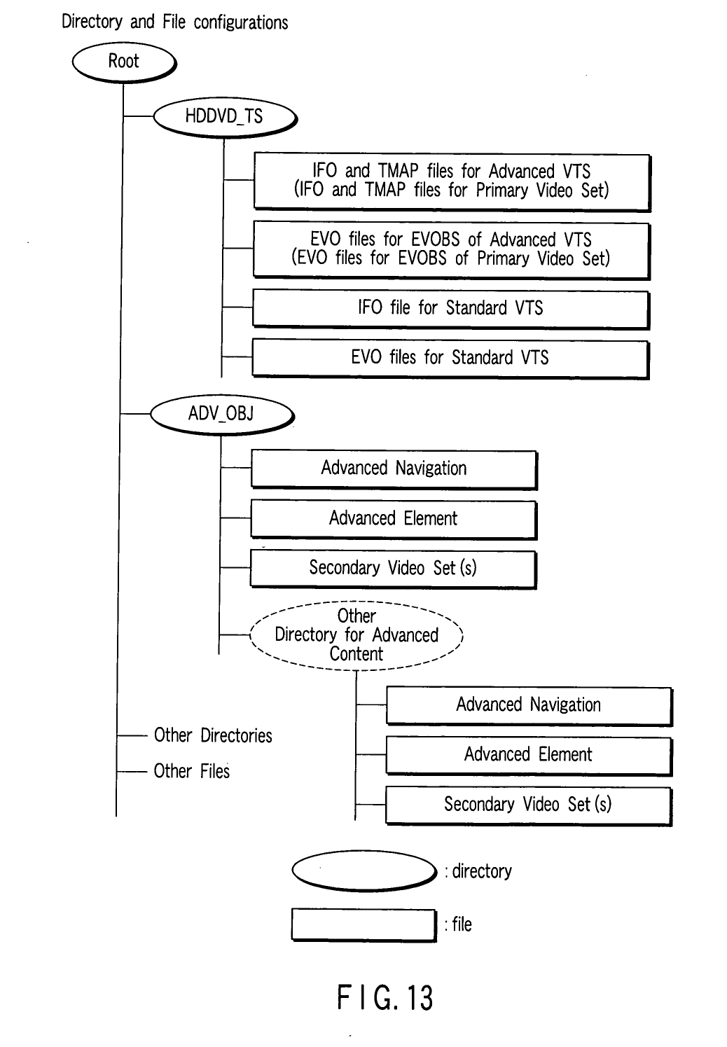

FIG. 13 shows the configuration of directories and files in association with the file system. As shown in FIG. 13, files for the advanced content are preferably located in directories.

HD DVD_TS Directory: An “HD DVD_TS” directory is located immediately under the root directory. One advanced VTS for the primary and one or a plurality of standard video sets are recorded under this directory.

ADV_OBJ Directory: An “ADV_OBJ” directory is located immediately under the root directory. All startup files which belong to advanced navigation are recorded under this directory. All advanced navigation, advanced elements, and secondary video set files are recorded under this directory.

Other Directory for Advanced Content: “Other directory for the advanced content” can exist only under the “ADV_OBJ” directory. The advanced navigation, advanced element, and secondary video set files can be recorded under this directory. This directory name is configured by d-characters and d1-characters. The total number of “ADV_OBJ” subdirectories (except for the “ADV_OBJ” directory) is less than 512. The depth of directory layers is 8 or less.

Advanced Content Files: The total number of files under the “ADV_OBJ” directory is limited to 512×2047, and the total number of files in each directory is less than 2048. This file name is configured by d-characters or d1-characters, and includes a body, “.”, and extension.

<Data Type on Network Server and Persistent Storage>

All advanced content files except for the primary video set can be recorded on the network server and persistent storage. The advanced navigation can copy files on the network server or persistent storage to the file cache using a correct API. A secondary disc player can load secondary video sets from the disc, network server, or persistent storage onto a streaming buffer. Advanced content files except for the primary video set can be stored in the persistent storage.

<Model of Advanced Content Player>

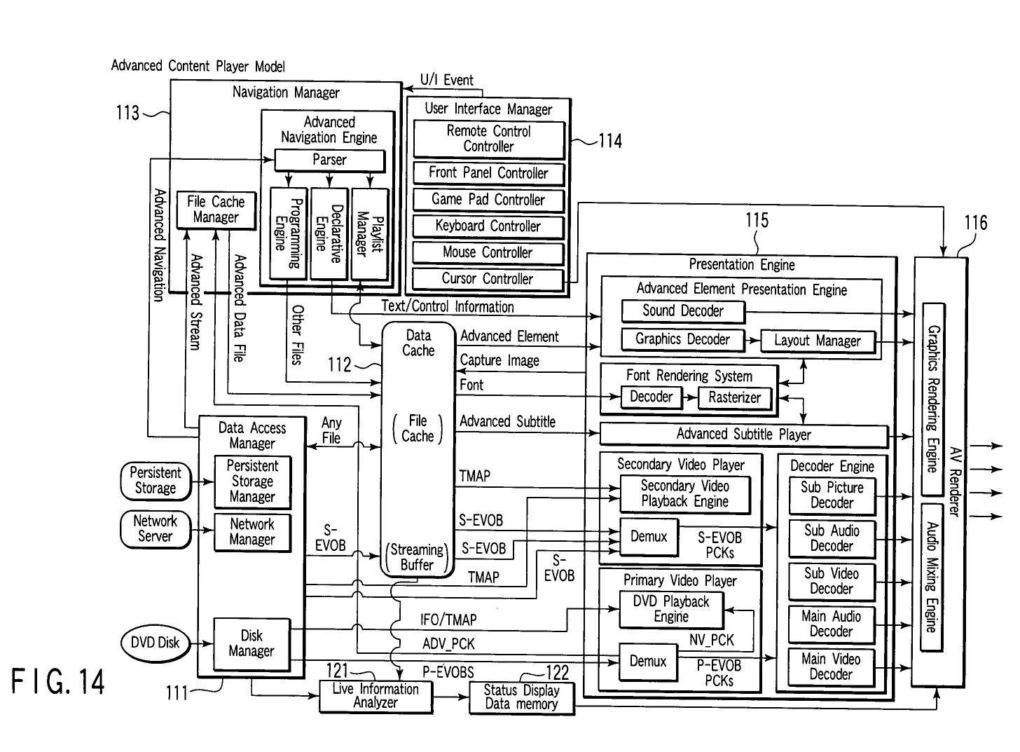

FIG. 14 shows the layout of the advanced content player in more detail. Principal modules include six modules, i.e., the data access manager, data cache, navigation manager, presentation engine, user interface manager, and AV renderer.

<Data Access Manager>

The data access manager comprises a disc manager, network manager, and persistent storage manger.

Persistent Storage Manager: The persistent storage manager controls data exchange between the persistent storage and internal modules of the advanced content player. The persistent storage manager serves to provide a file access API set to the persistent storage. The persistent storage can support a file read and write function.

Network Manager: The network manager controls data exchange between the network server and internal modules of the advanced content player. The network manager serves to provide a file access API set to the network server. The network manager normally supports a file download function, and can also support a file upload function depending on the network server. The navigation manager can download and upload files between the network server and file cache in accordance with the advanced navigation. In addition, the network manager can provide an access function on the protocol level to the presentation engine. A secondary video player in the presentation engine can use these API sets for streaming from the network server.

<Data Cache>

The data cache includes two types of temporary data storages. One storage is a file cache, i.e., a temporary buffer for file data. The other storage is a streaming buffer, i.e., a temporary buffer for streaming data. Assignment of streaming data in the data cache is described in “playlist00.xml”, and the streaming data is divided in the startup sequence of advanced content playback. The minimum size of the data cache is 64 MB, and its maximum size is not yet determined.

Initialization of Data Cache: The configuration of the data cache is changed in the startup sequence of advanced content playback. “playlist00.xml” can describe the streaming buffer size. If no description of the streaming buffer size is available, this means that the streaming buffer size is zero. The number of bytes of the streaming buffer size is calculated as follows.

<streamingBuf size=“1024”/>

Streaming buffer size=1024×2 (KBytes)
=2048 (KBytes)

The minimum streaming buffer size is zero bytes, and its maximum size is not yet determined.

File Cache: The file cache is used as a temporary file cache among the data sources, navigation engine, and presentation engine. The file cache stores advanced content files such as graphics images, sound effects, text, fonts, and the like prior to access from the navigation manager or an advanced presentation engine.

Streaming Buffer: The streaming buffer is used as a temporary data buffer for a secondary video set by a secondary video presentation engine of the secondary video player. The secondary video player requests the network manager to download some S-EVOB data of a secondary video set in the streaming buffer. The secondary video player loads S-EVOB data from the streaming buffer, and provides them to its demultiplexer module.

<Navigation Manager>

The navigation manager mainly comprises two types of function modules: an advanced navigation engine and file cache manager.

Advanced Navigation Engine: The advanced navigation engine controls all playback operations of the advanced content, and controls an advanced presentation engine according to the advanced navigation. The advanced navigation engine includes a parser, declarative engine, and programming engine.

Parser: The parser loads advanced navigation files and parses them. The parser sends the parsing result to appropriate modules, the declarative engine, and the programming engine.

Declarative Engine: The declarative engine manages and controls declared operations of the advanced content according to the advanced navigation. The declarative engine executes the following processing.
The declarative engine controls the advanced presentation engine, that is:
   layout of graphic objects and advanced text;
   styling of graphic objects and advanced text;
   timing control of programmed graphics plane operations and sound effect playback; and so forth.
The declarative engine controls the primary video player, that is:
   the configuration of the primary video set including registration of the title playback sequence (title timeline);
   control of a high-level player; and so forth.
The declarative engine controls the secondary video player, that is:
   the configuration of a secondary video set;
   control of a high-level player; and so forth.

Programming Engine: The programming engine manages event driven behaviors, API (application interface) set calls, or all advanced content files. Since the programming engine normally handles user interface events, the advanced navigation operations defined in the declarative engine may be changed.

File Cache Manager: The file cache manager executes the following processing:
to provide files archived in the advanced stream in the P-EVOBS from a demultiplexer module of the primary video player;
to provide files archived in the network server or persistent storage;
to manage the life periods of files in the file cache; and
to acquire files when files requested from the advanced navigation or presentation engine are not stored in the file cache.

The file cache manager comprises an ADV_PCK buffer and file extractor.

ADV_PCK Buffer: The file cache manager receives PCKs of the advanced stream archived in the P-EVOB-TY2 from the demultiplexer module of the primary video player. A PS header of each advanced stream PCK is deleted, and basic data is stored in the ADV_PCK buffer. The file cache manager acquires advanced stream files in the network server or persistent storage again.

File Extractor: The file extractor extracts archived files from the advanced stream into the ADV_PCK buffer. Extracted files are stored in the file cache.

<Presentation Engine>

The presentation engine decodes presentation data, and outputs decoded data to the AV renderer in accordance with navigation commands from the navigation engine. The presentation engine includes four types of modules: an advanced element presentation engine, secondary video player, primary video player, and decoder engine.

Advanced Element Presentation Engine: The advanced element presentation engine outputs two types of presentation streams to the AV renderer. One stream is a frame image of the graphics plane, and the other stream is a sound effect stream. The advanced element presentation engine comprises a sound decoder, graphics decoder, text/font rasterizer or font rendering system, and layout manager.

Sound Decoder: The sound decoder loads WAV files from the file cache, and outputs LPCM data to the AV renderer activated by the navigation engine.

Graphics Decoder: The graphics decoder acquires graphics data such as a PNG image, JPEG image, and the like from the file cache. The graphics decoder decodes these image files, and sends the decoded files to the layout manager in response to a request from the layout manager.

Text/Font Rasterizer: The text/font rasterizer acquires font data from the file cache, and generates a text image. The text/font rasterizer receives text data from the navigation manager or file cache. The text/font rasterizer generates a text image and sends the generated text image to the layout manager in response to a request from the layout manager.

Layout Manager: The layout manager generates a frame image of the graphics plane with respect to the AV renderer. When the frame image is changed, the layout manager receives layout information from the navigation manager. The layout manager calls the graphics decoder to decode specific graphics objects to be set on the frame image. The layout manager also calls the font/text rasterizer to similarly generate specific text objects to be set on the frame image. The layout manager lays out graphical images at appropriate locations from the lowermost layer, and calculates pixel values if each object includes an alpha channel or value. Finally, the layout manager outputs the frame image to the AV renderer.

Advanced Subtitle Player: An advanced subtitle player includes a timing engine and layout engine.

Font Rendering System: The font rendering system has a font engine, scaler, alphamap generation, and font cache.

Secondary Video Player: The secondary video player plays a complementary video content, complementary audio, and complementary subtitle. These complementary presentation contents are normally stored in the disc, network server, and persistent storage. If these contents are stored on the disc, they cannot be accessed from the secondary video player if the contents are not stored in the file cache. When these contents are downloaded from the network server, they are immediately stored in the streaming buffer before being supplied to a demultiplexer and decoders, thus avoiding any data losses due to bit rate variations in a network transfer path. The secondary video player comprises a secondary video playback engine and demultiplexer. The secondary video player connects appropriate decoders in the decoder engine according to the stream types of the secondary video set.

Since the secondary video set cannot hold two audio streams at the same time, only one audio decoder is always connected to the secondary video player.

Secondary Video Playback Engine: The secondary video playback engine controls all function modules of the secondary video player in accordance with a request from the navigation manager. The secondary video playback engine loads and analyzes a TMAP file and recognizes an appropriate read position of an S-EVOB.

Demultiplexer (Demux): The demultiplexer loads an S-EVOB stream, and sends demultiplexed packs to decoders connected to the secondary video player. The demultiplexer outputs S-EVOB PCKs at SCR timings. When an S-EVOB includes one of video, audio, and advanced subtitle streams, the demultiplexer provides it to the decoder at appropriate SCR timings.

Primary Video Player: The primary video player plays the primary video set. The primary video set has to be stored on the disc. The primary video player comprises a DVD playback engine and demultiplexer. The primary video player connects appropriate decoders of the decoder engine in accordance with the stream types of the primary video set.

DVD Playback Engine: The DVD playback engine controls all function modules of the primary video player in accordance with a request from the navigation manager. The DVD playback engine loads and analyzes IFO and TMAP files, recognizes an appropriate read position of the P-EVOB-TY2, and controls special playback functions of the primary video set such as multi-angle, audio/sub-picture selection, sub video/audio playback, and the like.

Demultiplexer: The demultiplexer loads the P-EVOB-TY2 into the DVD playback engine, and sends packs to appropriate decoders connected to the primary video player. The demultiplexer outputs respective PCKs of the P-EVOB-TY2 to respective decoders at appropriate SCR timings. In the case of a multi-angle stream, appropriate interleaved blocks of the P-EVOB-TY2 on the disc are loaded in accordance with the position information of TMAP information or navigation packs (N_PCK). The demultiplexer provides audio packs (A_PCK) of appropriate numbers to a main audio decoder or sub audio decoder, and sub-picture packs of appropriate numbers to an SP decoder.

Decoder Engine: The decoder engine comprises six types of decoders, i.e., a timed text decoder, sub-picture decoder, sub audio decoder, sub video decoder, main audio decoder, and main video decoder. These decoders are controlled by the playback engines of the connected players.

Timed Text Decoder: The timed text decoder can be connected only to the demultiplexer module of the secondary video player. The timed text decoder decodes an advanced subtitle in a format based on timed text in accordance with a request from the DVD playback engine. One of the timed text decoder and sub-picture decoder can be activated at a time. An output graphics plane is called a sub-picture plane, and is shared by the outputs from the timed text decoder and sub-picture decoder.

Sub-Picture Decoder: The sub-picture decoder can be connected to the demultiplexer module of the primary video player. The sub-picture decoder decodes sub-picture data in accordance with a request from the DVD playback engine. One of the timed text decoder and sub-picture decoder can be activated at a time. The output graphics plane is called a sub-picture plane, and is shared by the outputs from the timed text decoder and sub-picture decoder.

Sub Audio Decoder: The sub audio decoder can be connected to the demultiplexer modules of the primary video player and secondary video player. The sub audio decoder can support two audio channels and a sampling rate up to 48 kHz. This is called sub audio. The sub audio is supported as a sub audio stream of the primary video set, an audio only stream of the secondary video set, and an audio and video multiplexer stream of the secondary video set. The output audio stream of the sub audio decoder is called a sub audio stream.

Sub Video Decoder: The sub video decoder can be connected to the demultiplexer modules of the primary video player and secondary video player. The sub video decoder can support an SD-resolution video stream (maximum support resolution is in preparation) called sub video. The sub video is supported as a video stream of the secondary video set, and a sub video stream of the primary video set. The output video plane of the sub video decoder is called a sub video plane.

Main Audio Decoder: The main (primary) audio decoder can be connected to the demultiplexer modules of the primary video player and secondary video player. The primary audio decoder can support 7.1 multi audio channels, and a sampling rate up to 96 kHz. This is called main audio. The main audio is supported as a main audio stream of the primary video set, and an audio only stream of the secondary video set. The output audio stream of the main audio decoder is called a main audio stream.

Main Video Decoder: The main video decoder is connected only to the demultiplexer of the primary video player. The main video decoder can support an HD-resolution video stream. This is called support main video. The main video is supported in only the primary video set. The output video plane of the main video decoder is called a main video plane.

<AV Renderer>

The AV renderer has two roles. One role is to collect graphics planes from the presentation engine, interface manager, and output mixed video signal. The other role is to collect PCM streams from the presentation engine and output mixed audio signal. The AV renderer comprises a graphic rendering engine and audio mixing engine.

Graphic Rendering Engine: The graphic rendering engine acquires four graphics planes from the presentation engine, and one graphic frame from the user interface. The graphic rendering engine mixes these five planes in accordance with control information from the navigation manager, and outputs a mixed video signal.

Audio Mixing Engine: The audio mixing engine can acquire three LPCM streams from the presentation engine. The audio mixing engine mixes these three LPCM streams in accordance with mixing level information from the navigation manager, and outputs a mixed audio signal.

Video Mixing Model

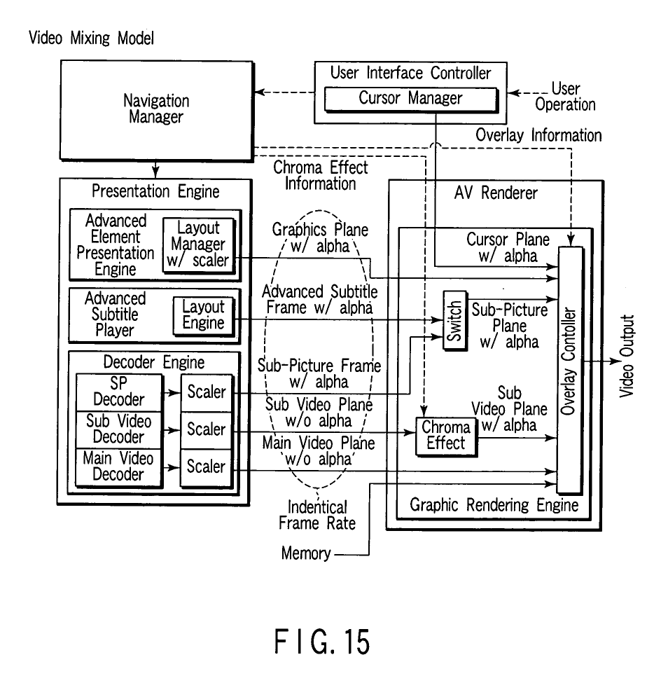

FIG. 15 shows a video mixing model. This model receives five graphics: a cursor plane, graphics plane, sub-picture plane, sub video plane, and main video plane.

Cursor Plane: The cursor plane is the uppermost plane of the five graphics input to the graphic rendering engine in this model. The cursor plane is generated by a cursor manager of the user interface manager. A cursor image can be replaced by the navigation manager in accordance with the advanced navigation. The cursor manager moves the cursor to an appropriate position on the cursor plane, and requests the graphic rendering engine to update it. The graphic rendering engine acquires the cursor plane and alpha mix, and lowers the plane in accordance with alpha information of the navigation engine.

Graphics Plane: The graphics plane is the second plane of the five graphics input to the graphic rendering engine in this model. The graphics plane is generated by the advanced element presentation engine in accordance with the navigation engine. The layout manager generates a graphics plane using the graphics decoder and text/font rasterizer. The size and rate of an output frame are equal to the video output of this model. An animation effect can be implemented by a series of graphics images (cell animations). A navigation manager of an overlay controller does not provide any alpha information for this plane. These values are provided to an alpha channel of the graphics plane itself.

Sub-Picture Plane: The sub-picture plane is the third plane of the five graphics input to the graphic rendering engine in this model. The sub-picture plane is generated by the timed text decoder or sub-picture decoder of the decoder engine. The primary video set can include a set of appropriate sub-picture images to have the size of the output frame. If an appropriate size of an SP image is known, the SP decoder directly transmits the generated frame image to the graphic rendering engine. If an appropriate size of an SP image is unknown, a scaler after the output side of the SP decoder measures an appropriate size and position of a frame image, and transmits them to the graphic rendering engine.

The secondary video set can include an advanced subtitle for the timed text decoder. Output data from the sub-picture decoder holds alpha channel information.

Sub Video Plane: The sub video plane is the fourth plane of the five graphics input to the graphic rendering engine in this model. The sub video plane is generated by the sub video decoder of the decoder engine. The sub video plane is measured by a scaler of the decoder engine in accordance with information from the navigation manager. The output frame rate is identical to the final video output. Clipping of an object shape in the sub video plane is executed by a chroma effect module of the graphic rendering engine as long as information is provided. Chroma color (or range) information is provided from the navigation manager in accordance with the advanced navigation. An output plane from the chroma effect module includes two alpha values. One value indicates 100% visible, and the other value indicates 100% transparent. As for overlay on the main video plane as the lowermost layer, an intermediate alpha value is provided from the navigation manager, and the overlay controller of the graphic rendering engine attains this overlay.

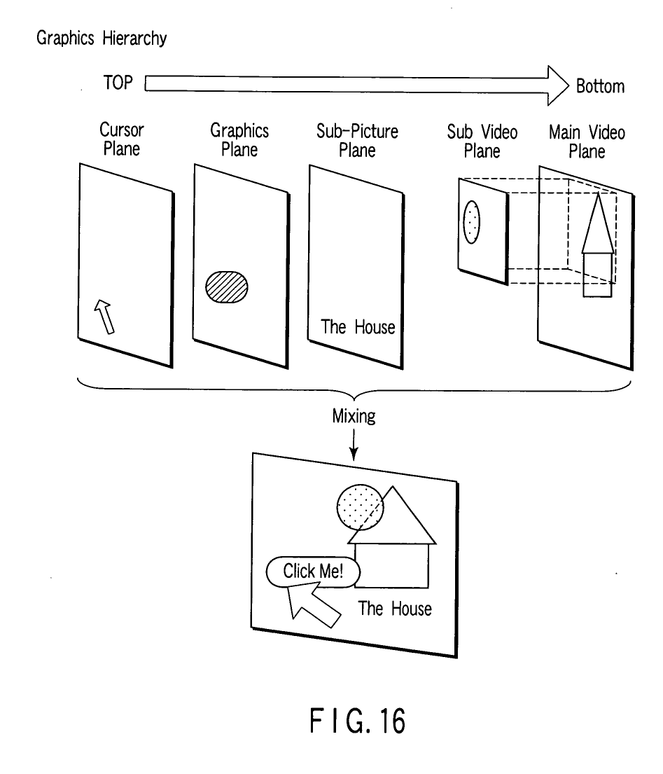

Main Video Plane: The main video plane is the lowermost plane of the five graphics input to the graphic rendering engine in this model. The main video plane is generated by the main video decoder of the decoder engine. The main video plane is measured by a scaler of the decoder engine in accordance with information from the navigation manager. The output frame rate is identical to the final video output. When the navigation manager measures according to the advanced navigation, an outer frame can be set for the main video plane. The default color value of an outer frame is “0,0,0” (=black). The graphics hierarchy in FIG. 16 shows the hierarchy of the graphics plane.

As described above, in the advanced content player, video and audio clips are selected according to object mapping information in the playlist, and objects included in these clips are played back using a timeline as a time base.

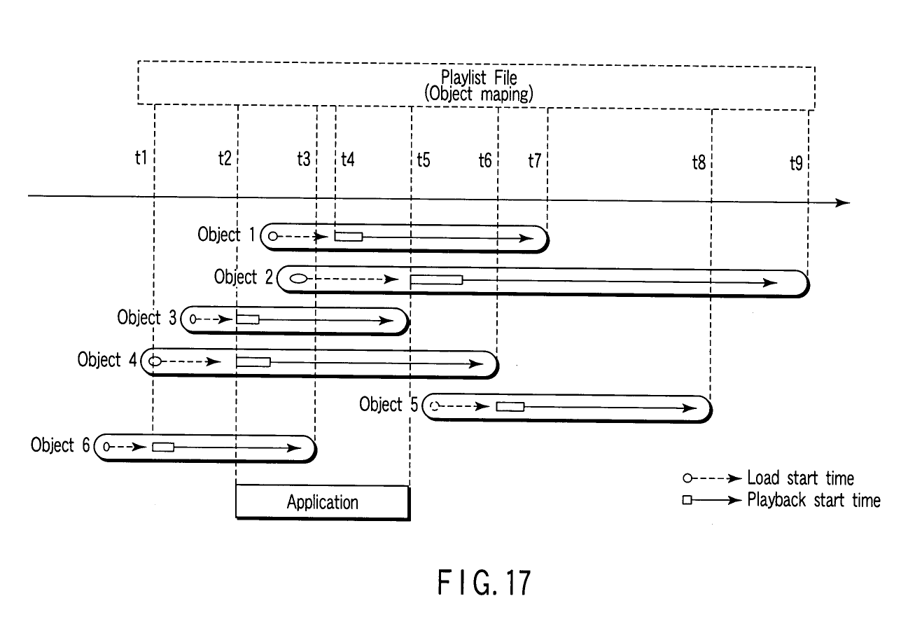

FIG. 17 shows a playback state of objects according to the playlist. Object 6 is played back from time t1 to time t3 on a timeline, object 4 is played back from time t2 to time t6, object 1 is played back from time t4 to time t7, object 2 is played back from time t5 to time t9, and object 5 is played back from time t6 to time t8. Object 3 is played back from time t2 to time t5.

As can be seen from the example of FIG. 17, an application is activated from time t2 to time t5. The objects and application are loaded onto the data cache prior to playback start. Note that the data access manager downloads management information including a time map from an external disc, and acquires objects described in the playlist. The data access manager outputs an object corresponding to the times (start and end times) designated in the playlist of the acquired object as an object to be temporarily stored.

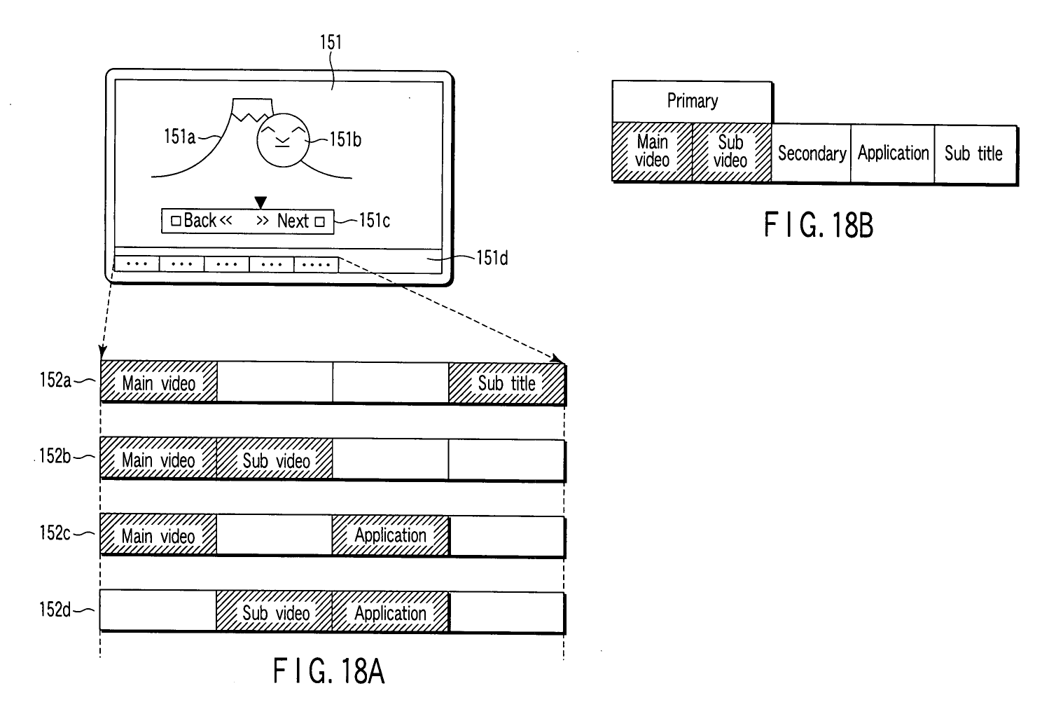

FIGS. 18A and 18B show a display example of video data output from the player of the invention on a screen of display device 151. This player can simultaneously superimpose and display, for example, main video 151a and sub video 151b. At the same time, the player can display control panel 151c based on an application.

Furthermore, since the player has live information analyzer 121 and status display data memory 122, as described above, status display indicating the source and/or objects of the content currently displayed on the screen can be made.

In order to make this status display, status display area 151 may be assured. Examples 152a to 152d and FIG. 18B show various status display examples. Example 152a is a display example when main video and subtitle are displayed. Example 152b is a display example when main video and sub video are simultaneously displayed. Example 152c is a display example when main video is displayed, and an application is activated. Example 152d is a display example when sub video displayed, and an application is activated.

Note that the above display example is that on the screen of display device 151. However, a display unit may be that directly provided to an information player. Furthermore, status display area 151d need not always be displayed, and when a combination of objects has changed, i.e., when the status has changed, that area may be displayed only for a predetermined period of time. Furthermore, display or non-display of status display area 151d may be selected by a user operation.

As described above, according to this player, even when a large number of types of objects are output to the display unit solely or while being superimposed, identification information of each object can be displayed by playlist analysis. Therefore, the user never misidentifies a sub video window on which sub video is displayed on the full screen in place of main video for a main video window. Since such misidentification is prevented, the user can adequately operate the player. Furthermore, the types of objects include an application fetched by navigation manager 113, and the application often controls the presentation engine and AV renderer. Also, in some cases, the output screen state is controlled in accordance with user operations. In such case, the user never performs an angle switch operation or the like by mistaking a secondary video window for the main video window when that secondary video window is displayed on the full screen like a slideshow.

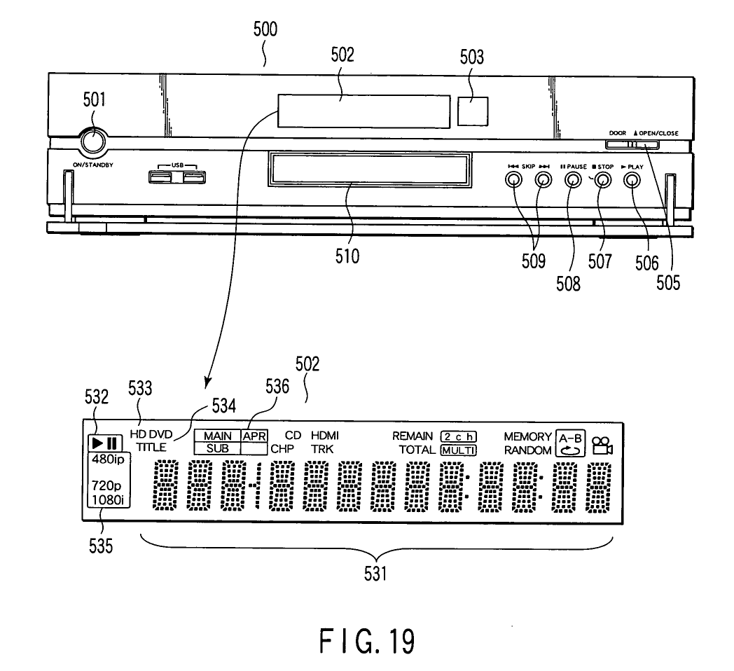

FIG. 19 is a front view of information player 500 to which the invention is applied. Reference numeral 501 denotes a power ON/OFF button; and 502, a display window which corresponds to display unit 134 described above. Reference numeral 503 denotes a remote-controller reception unit; and 505, a door open/close button. Reference numeral 506 denotes a play button; 507, a stop button; 508, a pause button; and 509, a skip button. Reference numeral 510 denotes a disc tray. Upon operation of door open/close button 505, the disc tray opens or closes to allow the user to exchange a disc.

Display window 502 has segment display units 531, which can display a total playback time, elapsed time, remaining time, title, and the like of a disc. Status display unit 532 can display playing, stopping, or pausing. Furthermore, disc identification display unit 533 is provided, and can display the type of the loaded disc (DVD, HD DVD, or the like). Title display unit 534 is provided and can display a title number. Unit 535 can display the resolution of the currently output video picture. As described above, this player allows the user to easily discriminate the type of the loaded disc. Also, live information status display 536 is provided, and allows the user to easily identify a main video display, sub video display, and application operation.

The player of the invention can support a single-sided, single-layer DVD; single-sided, single-layer HD DVD; single-sided, dual-layer DVD; single-sided, dual-layer HD DVD; double-sided DVD; double-sided HD DVD; one-side DVD & other-side HD DVD; and the like.

Characteristic configurations and operations of respective units of the player of the invention will be explained hereinafter to further explain the necessity of the aforementioned functions.

Audio Mixing Model

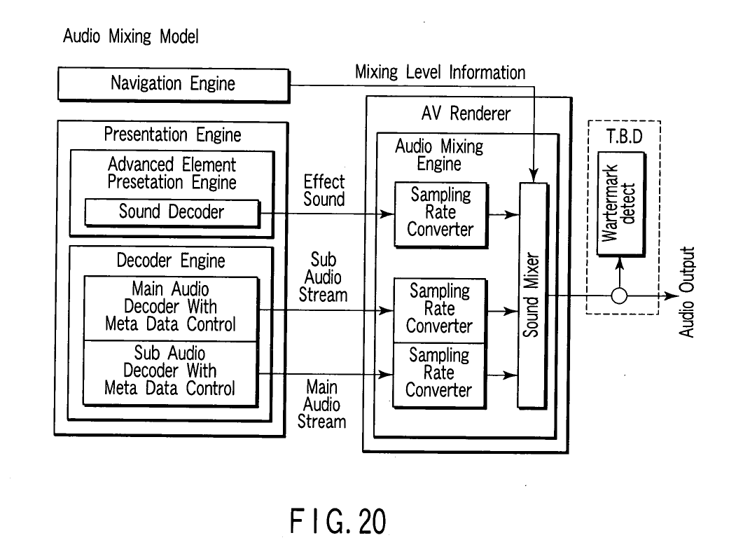

FIG. 20 shows an audio mixing model of this specification. There are three types of audio streams which are input to this model: a sound effect, secondary audio stream, and primary audio stream.

Sampling rate converters adjust audio sampling rates from respective sound and audio decoders to the sampling rate of a final audio output. A sound mixer of the audio mixing engine processes static mixing levels among the three types of audio streams in accordance with mixing level information from the navigation engine. A final output audio signal differs depending on the type of HD DVD player.

Sound Effect:

The sound effect is normally used upon clicking a graphical button. WAV formats of a single channel (mono) and stereo channels are supported. The sound decoder loads a WAV file from the file cache, and transmits an LPCM stream to the audio mixing engine in response to a request from the navigation engine.

Sub Audio Stream:

The sub audio stream includes two types. One is a sub audio stream of the secondary video set. When the secondary video set includes a sub video stream, secondary audio has to be the same as secondary video. When the secondary video set does not include any sub video stream, secondary audio may or may not be the same as the primary video set. The other is a sub audio stream of the primary video set. This sub audio stream has to be the same as that of the primary video. The sub audio decoder of the decoder engine performs meta data control in a basic stream of the sub audio stream.

Main Audio Stream:

The main audio stream is that for the primary video set. The main audio decoder of the decoder engine performs meta data control in a basic stream of the main audio stream.

User Interface Manager

The user interface manager includes some device controllers of user interfaces such as a front panel controller, remote control controller, keyboard controller, mouse controller, game pad controller, cursor controller, and the like, as shown in FIG. 14. Respective controllers confirm if respective devices are available, and monitor user operation events. User input events are supplied to an event handler of the navigation manager.

The cursor manager controls the shape and position of the cursor. The cursor manager updates the cursor plane in accordance with motion events from the mouse and related devices such as a game panel and the like.

<Disc Data Supply Model>

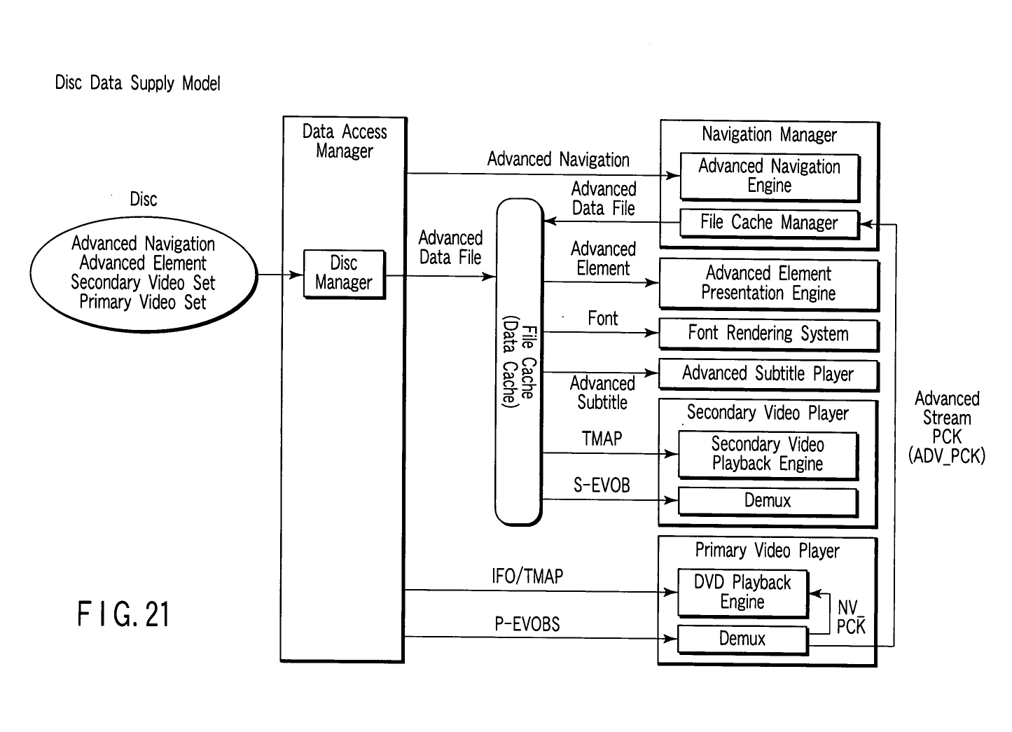

A disc data supply model shown in FIG. 21 represents a data supply model of the advanced content from the disc.

The disc manager provides a low-level disc access function and a file access function. The navigation manager acquires the advanced navigation of the startup sequence using the file access function. The primary video player can acquire IFO and TMAP files using the two functions. The primary video player normally requests to acquire the designated position of a P-EVOBS using the low-level disc access function. The secondary video player does not directly access data on the disc. Files are immediately stored on the file cache, and are loaded by the secondary video player.

When the demultiplexer module of the primary video player demultiplexes a P-EVOB-TY2, advanced stream packs (ADV_PCK) may be output. The advanced stream packs are sent to the file cache manager. The file cache manager extracts files archived in the advanced stream, and stores them in the file cache.

<Network and Persistent Data Supply Model>

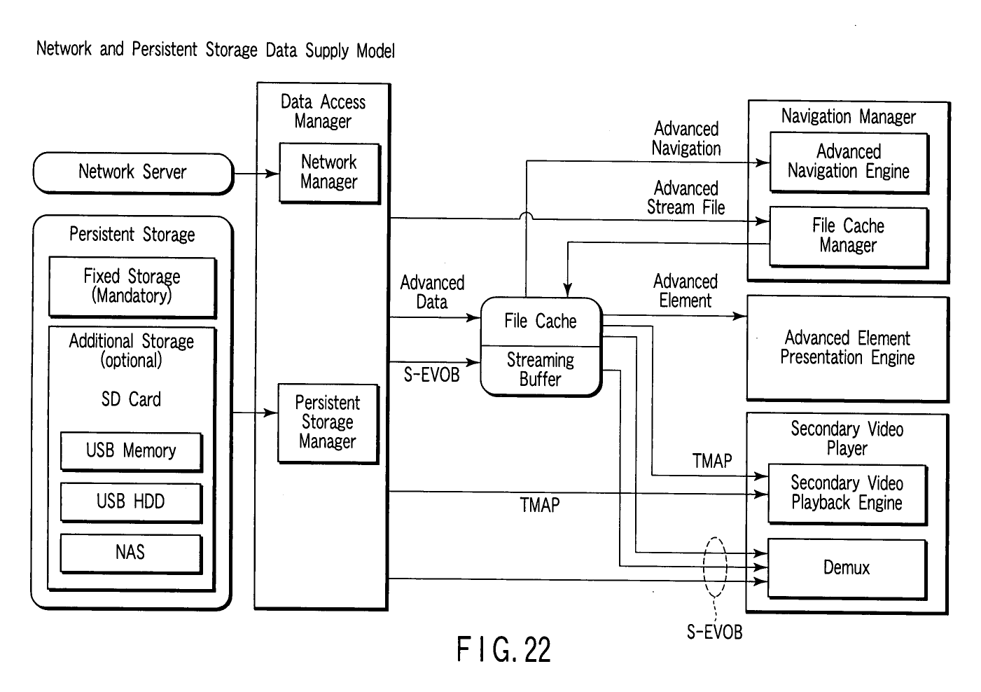

A network and persistent storage data supply model in FIG. 22 represents a data supply model of the advanced content from the network server and persistent storage.

The network server and persistent storage can store all advanced content files except for the primary video set. The network manager and persistent storage manager provide a file access function. The network manager also provides a protocol-level access function.

The file cache manager of the navigation manager can directly acquire advanced stream files (archived format) from the network server and persistent storage via the network manager and persistent storage manager. The advanced navigation engine cannot directly access the network server and persistent storage. Files should be immediately stored in the file cache before they are loaded by the advanced navigation engine.

The advanced element presentation engine can process files on the network server and persistent storage. The advanced element presentation engine calls the file cache manager to acquire files which are not stored in the file cache. The file cache manager compares the requested file with a file cache table to see if they are cached in the file cache. If the files are cached in the file cache, the file cache manager directly passes the file data to the advanced element presentation engine. If the files are not cached in the file cache, the file cache manager acquires files from their original locations onto the file cache, and passes file data to the advanced element presentation engine.

The secondary video player acquires secondary video set files like TMAP files, S-EVOB data, and the like from the network server and persistent storage via the network manager and persistent storage manager like in the case of the file cache. Normally, the secondary video playback engine acquires S-EVOB data from the network server using the streaming buffer. Some S-EVOB data are immediately stored in the streaming buffer and are provided to the demultiplexer module of the secondary video player.

<Data Store Model>

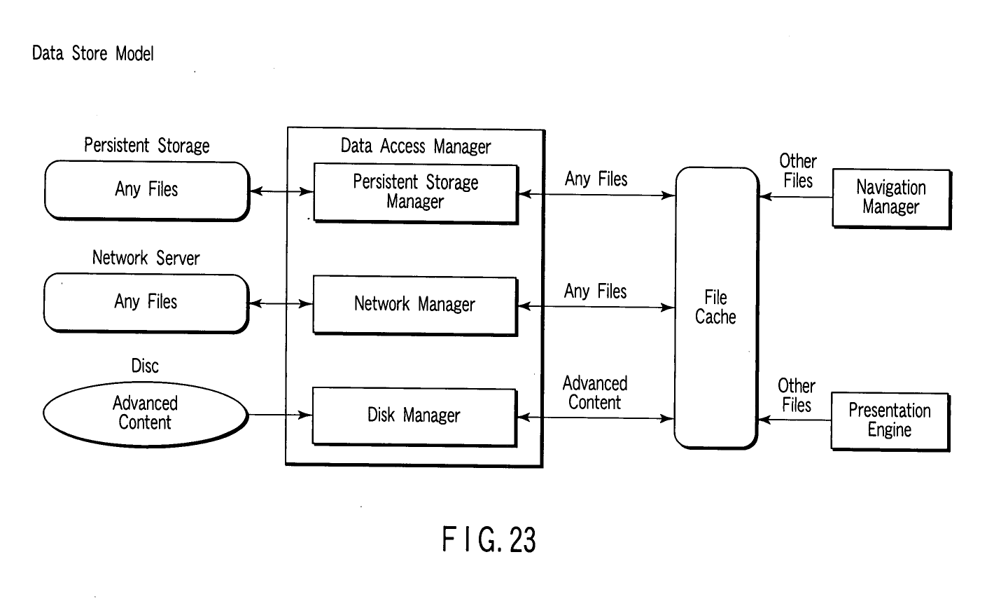

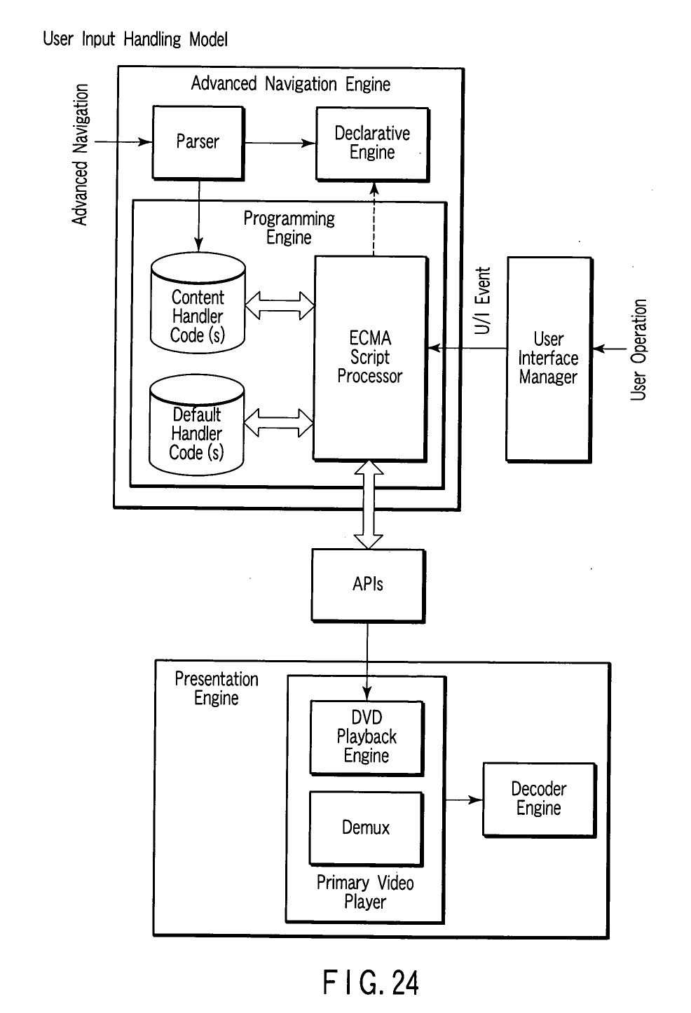

A data store model in FIG. 23 will be described below. There are two types of data storages, i.e., the persistent storage and network server. Upon playback of the advanced content, two types of files are generated. One file is of a dedicated type, and is generated by the programming engine of the navigation manager. The format of the file differs depending on the descriptions of the programming engine. The other file is an image file, which is collected by the presentation engine.

<User Input Model (FIG. 24)>

All user input events are handled by the programming engine. User operations via user interface devices such as the remote controller, front panel, and the like are input first to the user interface manager. The user interface manager converts an input signal for each player into an event defined like “UIEvent” of “InterfaceRemoteControllerEvent”. The converted user input event is transmitted to the programming engine.

The programming engine includes an ECMA script processor, and executes programmable operations. The programmable operations are defined by the description of an ECMA script provided by the script file of the advanced navigation. A user event handler code defined in the script file is registered in the programming engine.

Upon reception of a user input event, the ECMA script processor confirms if the current event corresponds to a handler code registered in the content handler codes. If the current event corresponds to the registered handler, the ECMA script processor executes that handler. If the handler is not registered, the ECMA script processor searches for a default handler code. If the corresponding default handler code is found, the ECMA script processor executes it. If the default handler code is not found, the ECMA script processor cancels the event or outputs an alarm signal.
Video Output Timing: Video data which is played back and decoded is externally output under the control of the decoder engine.
SD Conversion of Graphic Plane: The graphic plane is generated by the layout manager of the advanced element presentation engine. When the resolution of the generated frame does not match a final video output resolution of the HD DVD player, the scaler function of the layout manager measures the graphic frame in accordance with the current output mode such as SD pan-scan, SD letter box, or the like. A scaling function for attaining a pan or scan and that for obtaining a letter box output are also provided.

<Presentation Timing Model>

The advanced content presentation is managed by a master time which defines the synchronization relationship between the presentation schedule and presentation objects. The master time is called a title timeline. The title timeline is defined for each logical playback time, which is called a title. The timing unit of the title timeline is 90 kHz. There are five types of presentation objects: a primary video set PVS), secondary video set (SVS), complementary audio, complementary subtitle, and advanced application (ADV_APP).

<Presentation Object>

Five types of presentation objects are as follows:
primary video set (PVS);
secondary video set (SVS);
   sub video/sub audio;
   sub video;
   sub audio;
complementary audio (for primary video set);
complementary subtitle (for primary video set); and
advanced application (ADV_APP)

<Attributes of Presentation Object>

The presentation object includes two types of attributes. One attribute is “scheduled”, and the other attribute is “synchronized”.

<Scheduled and Synchronized Presentation Object>

The start and end times of this object type are assigned in advance to the playlist file. The presentation timing is synchronized with the time on the title timeline. The primary video set, complementary audio, and complementary subtitle are of this object type. The secondary video set and advanced application are handled as this object type.

<Scheduled and Non-Synchronized Presentation Object>

The start and end times of this object type are assigned in advance to the playlist file. The presentation timing is the time base of itself. The secondary video set and advanced application are handled as this object type.

<Non-Scheduled and Synchronized Presentation Object>

This object type is not described in the playlist file. This object is activated by a user event handled by the advanced application. The presentation timing is synchronized with the title timeline.

<Non-Scheduled and Non-Synchronized Presentation Object>

This object type is not described in the playlist file. This object is activated by a user event handled by the advanced application. The presentation timing is the time base of itself.

<Playlist File>

The playlist file has two use purposes for advanced content playback. One purpose is for the initial system configuration of the HD DVD player, and the other purpose is for the definition of a method of playing a plurality of presentation contents of the advanced content. The playlist file includes the following advanced content playback configuration information:
object mapping information of each title;
playback sequence of each title; and
system configuration of advanced content playback.

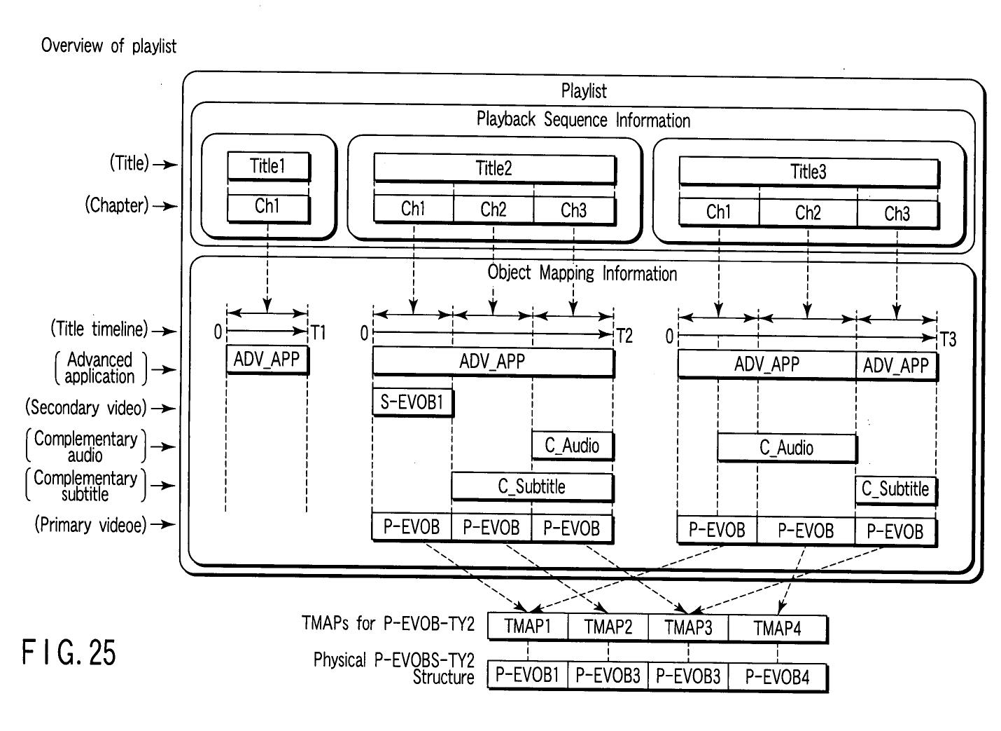

FIG. 25 shows an overview of the playlist except for the system configuration.

<Object Mapping Information>

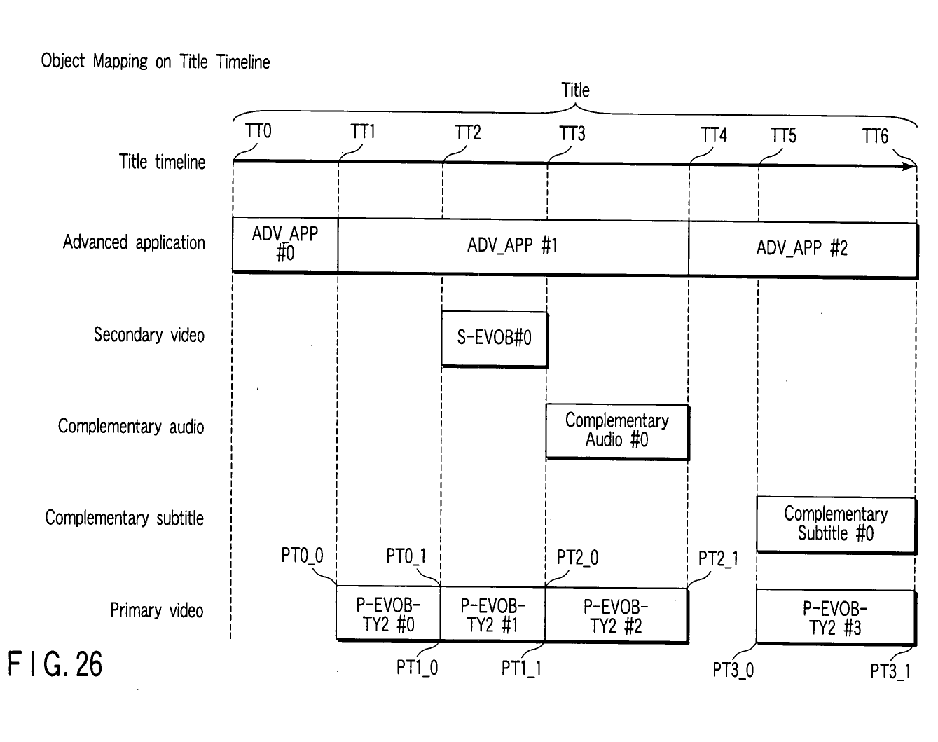

The title timeline defines for each title the timing relationship between the default playback sequence and presentation objects. The scheduled presentation objects of the advanced application, primary video set, or secondary video set assign their operation time periods (from the start time to the end time) to the title timeline in advance. FIG. 26 shows the object mapping state onto the title timeline. Along with an elapse of the title timeline, respective presentation objects start and end their presentation. When presentation objects are synchronized with the title timeline, the operation time period of the title timeline assigned in advance becomes equal to the presentation time period.

Example) TT2−TT1=PT1_1−PT1_0

where PT1_0 is the presentation start time of P-EVOB-TY2#1, and PT1_1 is the presentation end time of P-EVOB-TY2#1.

The following description is an example of the object mapping information.

<Title id=“MainTitle”>

<PrimaryVideoTrack id=“MainTitlePVS”>

<Clip id=“P-EVOB-TY2-0”

src=“file:///HDDVD_TS/AVMAP001.IFO”

titleTimeBegin=“01:00:00:00”

titleTimeEnd=“02:00:00:00” clipTimeBegin=“0”/>

<Clip id=“P-EVOB-TY2-1”

src=“file:///HDDVD_TS/AVMAP002.IFO”

titleTimeBegin=“02:00:00:00”

titleTimeEnd=“03:00:00:00” clipTimeBegin=“0”/>

<Clip id=“P-EVOB-TY2-2”

src=“file:///HDDVD_TS/AVMAP003.IFO”

titleTimeBegin=“03:00:00:00”

titleTimeEnd=“04:50:00:00” clipTimeBegin=“0”/>

<Clip id=“P-EVOB-TY2-3”

src=“file:///HDDVD_TS/AVMAP005.IFO”

titleTimeBegin=“05:00:00:00”

titleTimeEnd=“06:50:00:00” clipTimeBegin=“0”/>

</PrimaryVideoTrack>
<SecondaryVideoTrack id=“CommentarySVS”>

<Clip id=“S-EVOB-0”

src=“http://dvdforum.com/commentary/AVMAP001.TMAP”

titleTimeBegin=“05:00:00:00”

titleTimeEnd=“06:50:00:00“ clipTimeBegin=“0”/>

</SecondaryVideoTrack>
<Application id=“App0”

manifest=“file:///ADV_OBJ/App0/Manifest. xml” />

<Application id=“App0”

manifest=“file:///ADV_OBJ/Appl/Manifest.xml” />
</Title>

Object mapping among the secondary object set, complementary audio, and complementary subtitle has limitations. Since these three presentation objects are played back by the secondary video player, they are not simultaneously mapped on two or more title timelines.

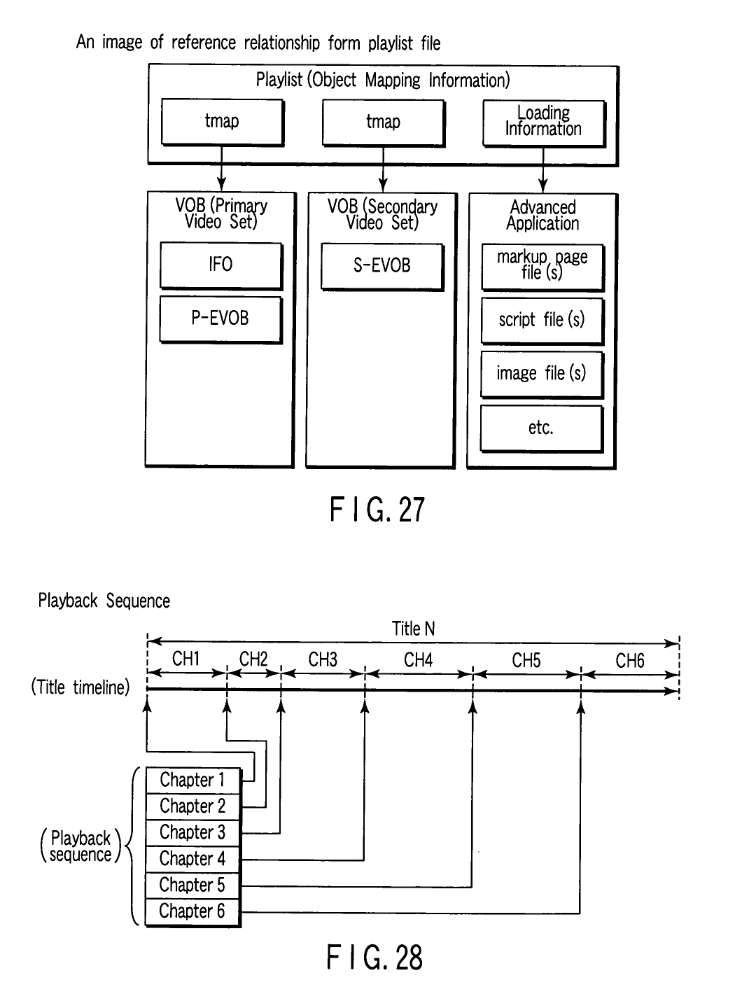

Upon assigning presentation objects to the title timeline of the playlist in advance, index information files of respective presentation objects are referred to, as shown in FIG. 27. In case of the primary video set and secondary video set, TMAP files are referred to by the playlist.

<Playback Sequence>

As shown in FIG. 28, the playback sequence defines the chapter start positions using the time values on the title timeline. To the end position of the chapter, the start position of the next chapter or the end position of the last chapter on the title timeline is applied.

The following description is an example of the playback sequence.

<ChapterList>

<Chapter titleTimeBegin=“0”/>
<Chapter titleTimeBegin=“01:00:00:00”/>
<Chapter titleTimeBegin=“02:00:00:00”/>
<Chapter titleTimeBegin=“02:55:00:00”/>
<Chapter titleTimeBegin=“03:00:00:00”/>
<Chapter titleTimeBegin=“04:55:55:00”/>

</ChapterList>

<Trick Play>

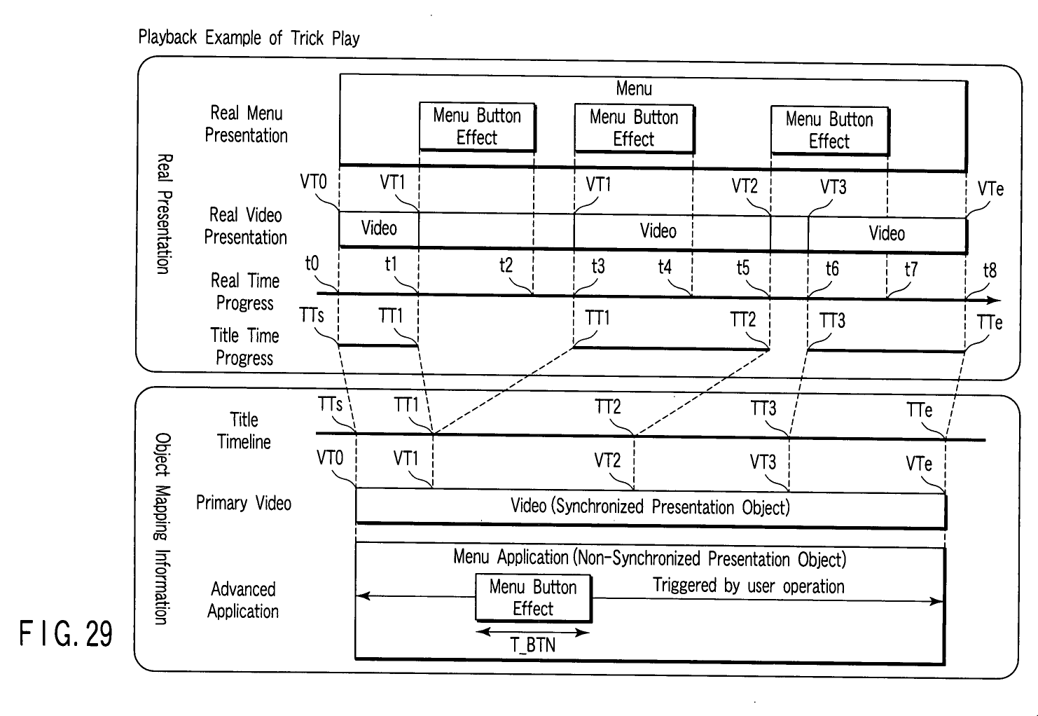

A playback example of trick play shown in FIG. 29 shows the related object mapping information on the title timeline, and real presentation.

There are two presentation objects. One object is a primary video, and is a synchronized presentation object. The other is an advanced application for menu, and is a non-synchronized presentation object. The menu is premised on the fact that a playback control menu is provided to the primary video. Also, the playback control menu is premised on the fact that it includes a plurality of menu buttons clicked by user operations. Each menu button has a graphical effect. An effect duration is “T_BTN”.

<Real Time Progress (t0)>

Advanced content presentation starts at time ‘t0’ of the real time progress. Along with the time progress of the title timeline, the primary video is played back. The menu application starts its presentation at ‘t0’, but the presentation does not depend on the time progress of the timeline.

<Real Time Progress (t1)>

The user clicks a “pause’ button presented by the menu application at time ‘t1’ of the real time progress. At this time, a script related to the ‘pause’ button pauses the time progress of the timeline at TT1. When the title timeline pauses, the video presentation also pauses at VT1. Conversely, the menu application continues its operation. That is, a menu button effect related to the ‘pause’ button starts from ‘t1’.

<Real Time Progress (t2)>

The effect of the menu button ends at time ‘t2’ of the real time progress. A ‘t2-t1’ time period is equal to the button effect duration ‘T_BTN’.

<Real Time Progress (t3)>

The user clicks a ‘play’ button presented by the menu application at time ‘t3’ of the real time progress. At this time, a script related to the ‘play’ button starts the time progress of the timeline at TT1. When the title timeline starts, the video presentation also starts from VT1. A menu button effect related to the ‘play’ button starts from ‘t3’.

<Real Time Progress (t4)>

The menu button effect ends at time ‘t4’ of the real time progress. A ‘t3-t4’ time period is equal to the button effect duration ‘T_BTN’.

<Real Time Progress (t5)>

The user clicks a ‘jump’ button presented by the menu application at time ‘t5’ of the real time progress. At that time, a script related to the ‘jump’ button jumps the time of the timeline by a specific jump time TT3. However, since the jump operation of the video presentation takes some time, the time of the title timeline at that time maintains ‘t5’. Conversely, since the menu application continues its operation, and is not related to the progress of the title timeline, a menu button effect related to the ‘jump’ button starts from ‘t5’.

<Real Time Progress (t6)>

The video presentation is ready to restart at any time from VT3 at time ‘t6’ of the real time progress. At this time, the title timeline starts from TT3. Upon starting the title timeline, the video presentation also starts from VT3.

<Real Time Progress (t7)>

The menu button effect ends at time ‘t7’ of the real time progress. A ‘t7-t5’ time period is equal to the button effect duration ‘T_BTN’.

<Real Time Progress (t8)>

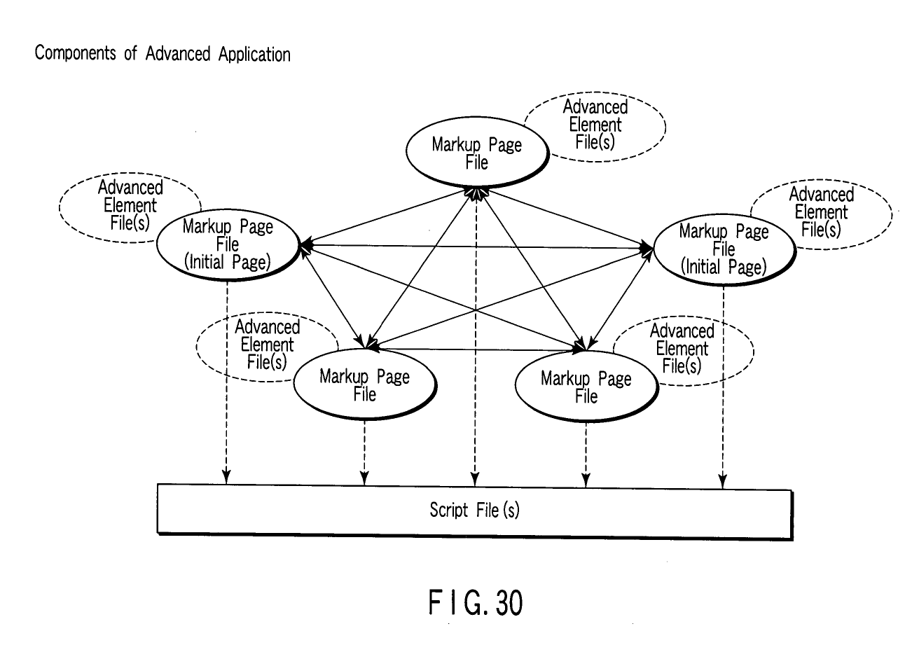

The timeline has reached end time TTe at time ‘t8’ of the real time progress. Since the video presentation has also reached VTe, presentation ends. Since the operation time of the menu application is assigned to TTe of the title timeline, the presentation of the menu application also ends at TTe.

<Advanced Application: See FIG. 30>

The advanced application (ADV_APP) is configured by markup page files with one- or two-way links, a script file which shares a name space which belongs to the advanced application, and advanced element files used by the markup page files and script file.

Upon presentation of the advanced application, the number of active markup pages is always one. The active markup page jumps from one page to the other page. <The playback sequence of the advanced content will be described below.>

<Startup Sequence of Advanced Content>

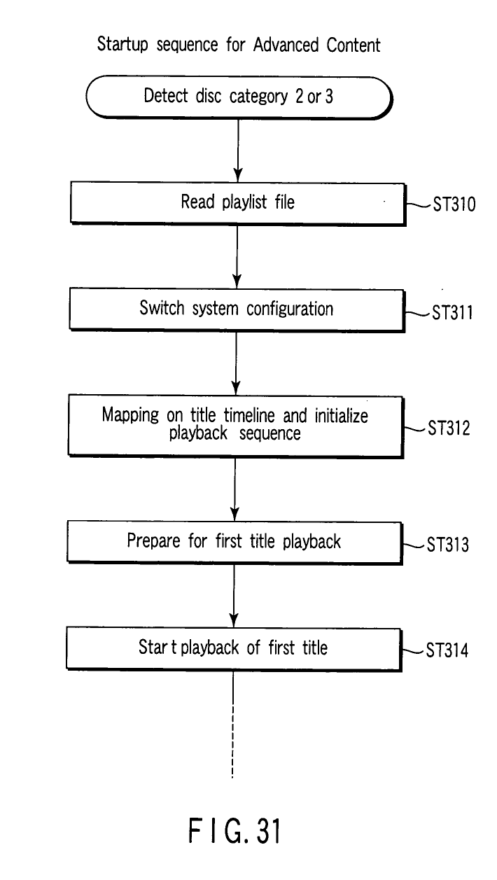

FIG. 31 is a flowchart showing the startup sequence of the advanced content on the disc.

Load Initial Playlist File:

If it is detected that the category type of the inserted HD DVD disc is 2 or 3, the advanced content player loads an initial playlist file which holds the object mapping information, playback sequence, and system configuration, e.g., in turn (ST310).

Change System Configuration:

The player changes the system resource configuration of the advanced content player (ST311). The streaming buffer size is changed in accordance with that described in the playlist file in this step. Files and data stored in the file cache and streaming buffer at that time are all cleared.

Title Timeline Mapping and Initialization of Playback Sequence:

The navigation manager calculates the presentation locations of presentation objects and chapter entry points on the title timeline of a first title (ST312).

Playback Preparation of First Title:

The navigation manager loads and saves all files which are to be stored in the file cache before the beginning of playback of the first title (ST313). These files include advanced element files of the advanced element presentation engine or TMAP/S-EVOB files of the secondary video player engine. The navigation manager initializes presentation modules such as the advanced element playback engine, secondary video player, primary video player, and the like in this step.

If the first title includes primary video set presentation, the navigation manager notifies presentation mapping information of the primary video set on the title timeline of the first title, and designates navigation files such as IFO and TMAP files and the like of the primary video set. The primary video player loads the IFO and TMAP files from the disc, and prepares internal parameters used to control playback of the primary video set in accordance with the notified presentation mapping information. Furthermore, the primary video player and the used decoder modules of the decoder engine are connected.

If the first title includes presentation objects such as the secondary video set, complementary audio, complementary subtitle, and the like to be played by the secondary video player, the navigation manager notifies presentation mapping information of the first presentation object on the title timeline. Furthermore, the navigation manager designates navigation files such as TMAP files and the like for the presentation objects. The secondary video player loads TMAP files from the data source, and prepares internal parameters used to control playback of presentation objects in accordance with the notified presentation mapping information. Furthermore, the secondary video player and the used decoder modules of the decoder engine are connected.

Start Play of First Title:

Upon completion of preparation for playback of the first title, the advanced content player starts the title timeline (ST314). The presentation objects mapped on the title timeline start presentation in accordance with the presentation schedule.

<Update Sequence of Advanced Content Playback>

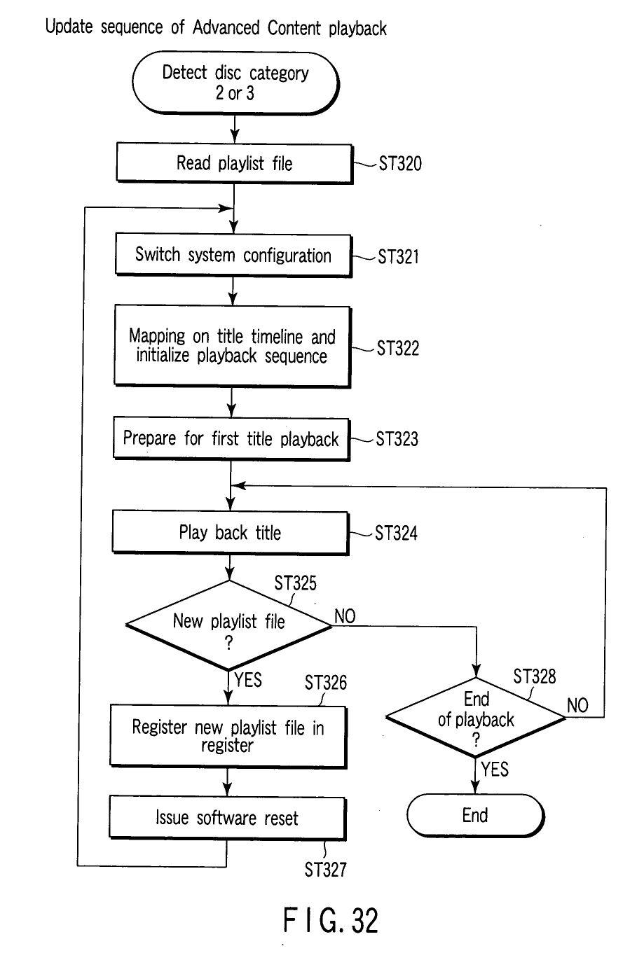

FIG. 32 is a flowchart showing the update sequence of advanced content playback. Steps “load playlist file” (ST320) to “playback preparation for first title” (ST323) are the same as those in the startup sequence of the advanced content.

Play Back Title:

The advanced content player plays back a title (ST324, NO in ST325, NO in ST328).

New Playlist File?:

In order to update advanced content playback, an advanced application that executes the update sequence is used. When the advanced application updates the presentation, the advanced application on the disc has to search for and update a script sequence in advance. The programming script searches the designated data source (normally, the network server) irrespective of the presence/absence of an available, new playlist file (YES or NO in ST325).

Register Playlist File:

If a useable, new playlist file is found (YES in ST325), the script executed by the programming engine downloads it onto the cache file, and registers the downloaded file in the advanced content player (ST326).

Issue Software Reset:

If the new playlist file is registered, the advanced navigation issues a software reset API to restart the startup sequence (ST327). The software reset API resets all the current parameters and playback configuration, and restarts the startup sequence immediately after “load playlist file”. Step “change system configuration” and subsequent steps are executed based on the new playlist file.

<Transition Sequence Between Advanced VTS and Standard VTS>

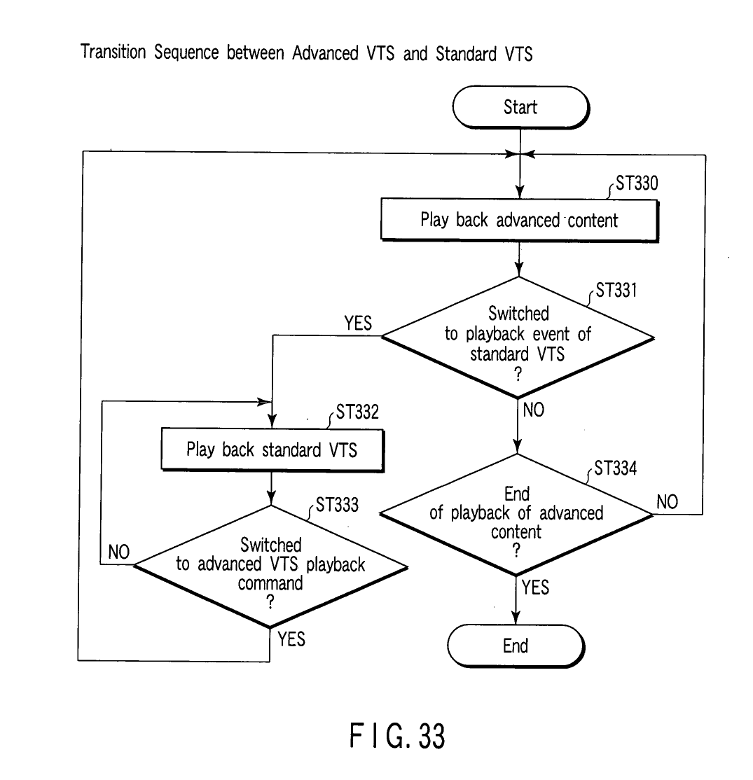

In case of playback of the disc of category type 3, playback transition between the advanced VTS and standard VTS is done. FIG. 33 is a flowchart showing the transition sequence between the advanced VTS and standard VTS.

Play Advanced Content:

Playback of the disc of category type 3 starts from advanced content playback (ST330, NO in ST331, NO in ST334). During this interval, user input events are handled by the navigation manager. The navigation manager has to transmit all user events to be handled by the primary video player to the primary video player.

Detect Standard VTS Playback Event:

The advanced content clearly specifies transition from advanced content playback to standard content playback by a “CallStandardContentPlayer” API of the advanced navigation. “CallStandardContentPlayer” can designate the playback start position as an argument. Upon detection of the “CallStandardContentPlayer” command (YES in ST331), the navigation manager requests the primary video player to pause playback of the advanced VTS, and calls the “CallStandardContentPlayer” command.

Play Standard VTS:

If the navigation manager issues the “CallStandardContentPlayer” API, the primary video player jumps from the designated location to the start position of the standard VTS. During this interval, since the navigation manager pauses, user events have to be directly input to the primary video player. Also, during this interval, the primary video player executes all playback transition processes with the standard VTS based on navigation commands (ST332).

Detect Advanced VTS Playback Command:

The standard content explicitly designates transition from standard content playback to advanced content playback by “CallAdvancedContentPlayer”. Upon detection of the “CallAdvancedContentPlayer” command (YES in ST333), the primary video player stops play of the standard VTS, and restarts the navigation manager from an execution position immediately after the “CallAdvancedContentPlayer” command is called (ST330).

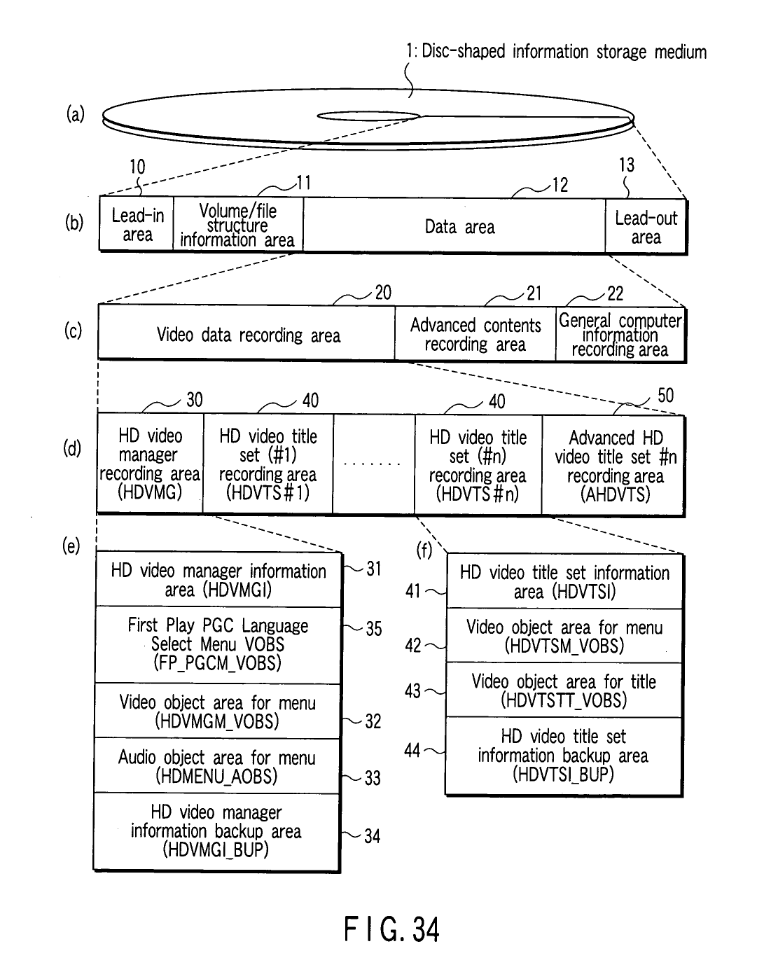

FIG. 34 is a view for explaining the information contents to be recorded on a disc-shaped information storage medium according to one embodiment of the invention. Information storage medium 1 indicated by symbol (a) of FIG. 34 can comprise, e.g., a high-density optical disc (high-density or high-definition digital versatile disc: HD_DVD for short) using, e.g., a red laser of a wavelength of 650 nm or blue laser of 405 nm (or less).

As indicated by symbol (b) in FIG. 34, information storage medium 1 includes lead-in area 10, data area 12, and lead-out area 13 from the inner periphery side. Information storage medium 1 adopts the ISO9660 and UDF bridge structures as a file system, and has ISO9660 and UDF volume/file structure information area 11 on the lead-in side of data area 12.

Data area 12 allows mixed allocations of video data recording area 20 used to record DVD-Video contents (also called a standard content or SD content), another video data recording area (advanced content recording area used to record advanced content) 21, and general computer information recording area 22, as indicated by symbol (c) in FIG. 34. (Note that the plural form “contents” includes the meaning of the singular form “content”, and the singular form “content” is a representative singular form.)

Video data recording area 20 includes HD video manager (HDVMG: High Definition-compatible Video Manager) recording area 30 that records management information associated with the entire HD_DVD-Video content recorded in video data recording area 20, HD video title set (HDVTS: High Definition-compatible Video Title Set: also called standard VTS) recording area 40 which are arranged for respective titles, and record management information and video information (video objects) for respective titles together, and advanced HD video title set (AHDVTS: advanced VTS) recording area 50, as indicated by symbol (d) of FIG. 34.

HD video manager (HDVMG) recording area 30 includes HD video manager information (HDVMGI: High Definition-compatible Video Manager Information) area 31 that indicates management information associated with overall video data recording area 20, HD video manager information backup (HDVMGI_BUP) area 34 that records the same information as in HD video manager information area 31 as its backup, and menu video object (HDVMGM_VOBS) area 32 that records a top menu screen indicating whole video data recording area 20, as indicated by symbol (e) of FIG. 34.

In one embodiment of the invention, HD video manager recording area 30 newly includes menu audio object (HDMENU_AOBS) area 33 that records audio information to be output parallelly upon menu display. Furthermore, in one embodiment of the invention, an area of first play PGC language select menu VOBS (FP_PGCM_VOBS) 35 which is executed upon first access immediately after disc (information storage medium) 1 is loaded into a disc drive is configured to record a screen that can set a menu description language code and the like.

HD video title set (HDVTS) recording area 40 that records management information and video information (video objects) together for each title includes HD video title set information (HDVTSI) area 41 which records management information for all contents in HD video title set recording area 40, HD video title set information backup (HDVTSI_BUP) area 44 which records the same information as in HD video title set information area 41 as its backup data, menu video object (HDVTSM_VOBS) area 42 which records information of menu screens for each video title set, and title video object (HDVTSTT_VOBS) area 43 which records video object data (title video information) in this video title set, as indicated by symbol (f) of FIG. 34.

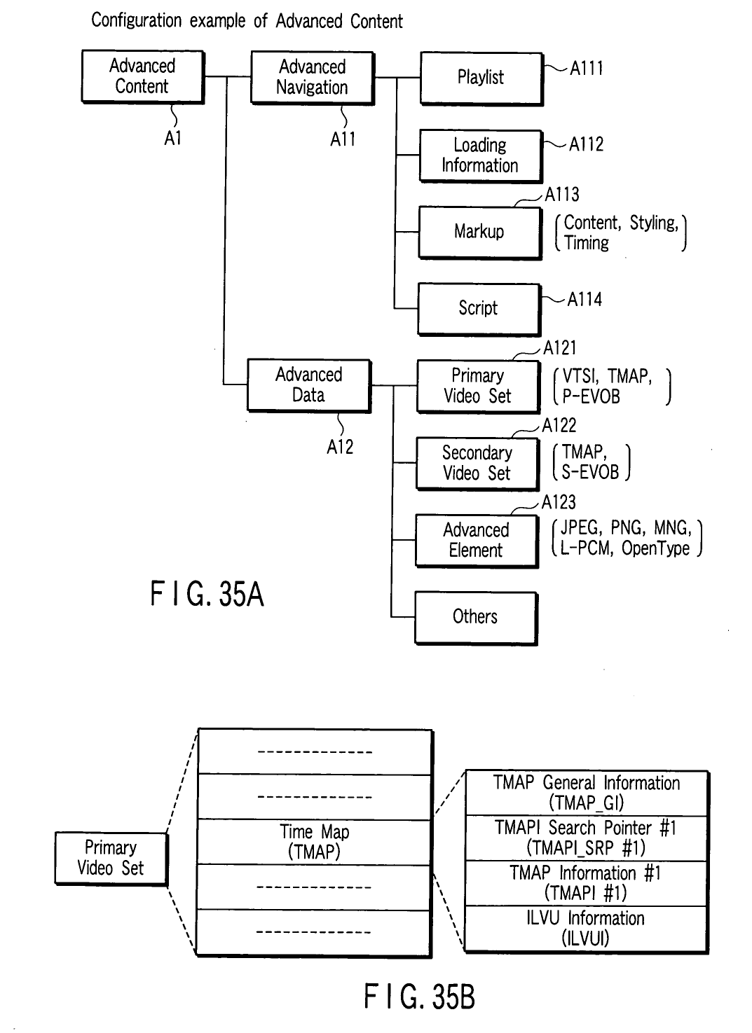

FIGS. 35A and 35B are views for explaining a configuration example of an advanced content stored in advanced content recording area 21 of the information storage medium shown in FIG. 34. Note that the advanced content need not always be stored in the information storage medium. For example, the advanced content may be provided from a server via the network.

As shown in FIG. 35A, an advanced content recorded in advanced content area A1 includes an advanced navigation used to manage a primary/secondary video set output, text/graphic rendering, and audio output, and advanced data including these data managed by the advanced navigation. The advanced navigation recorded in advanced navigation area A11 includes playlist files, loading information files, markup files (for content, styling, and timing information), and script files. Note that the playlist files are recorded in playlist files area A111. Loading information files are recorded in loading information files area A112. The markup files are recorded in markup files area A113. The script files are recorded in script files area A114.

The advanced data recorded in advanced data area A12 includes a primary video set (VTSI, TMAP, and P-EVOB data) including object data, secondary video set (TMAP and S-EVOB data) including object data, advanced elements (JPEG, PNG, MNG, L-PCM, OpenType font, etc.), and the like. The advanced data also includes object data which forms a menu (screen). For example, the object data included in the advanced data are played back during designated periods on a timeline based on time map (TMAP) data which has a format shown in FIG. 35B. The primary video set is recorded in primary video set area A121. The secondary video set is recorded in secondary video set area A122. The advanced elements are recorded in advanced element area A123.

The advanced navigation includes the playlist files, loading information files, markup files (for content, styling, and timing information), and script files. These files (playlist files, loading information files, markup files, and script files) are encoded as XML documents. Note that the advanced navigation engine reflects the resources of XML documents for the advanced navigation if they are not described in a correct format.

Each XML document becomes valid according to the definition of a reference document type. However, the advanced navigation engine (on the player side) does not always have a function of determining the validity of the content (content validity need only be guaranteed by the provider). If the resources of the XML documents are not described in a correct format, a normal operation of the advanced navigation engine is not guaranteed. The following rules apply to an XML declaration:
An encode declaration is “UTF-8” or “ISO-8859-1”. An XML file is encoded by one of these encoding schemes; and
The value of a standard document declaration in the XML declaration is “yes” if this standard document declaration exists. If no standard document declaration exists, this value is considered as “no”.

All resources which are available on the disc or network have addresses encoded by a Uniform Resource Identifier defined by [URI, RFC2396].

Protocols and paths supported for a DVD disc are, for example, as follows:

file://dvdrom:/dvd_advnav/file.xml

FIG. 35B shows a configuration example of a time map (TMAP). This time map includes time map information (TMAPI) as an element, which is used to convert the playback time in a primary enhanced video object (P-EVOB) into the address of a corresponding enhanced video object unit (EVOBU). The interior of the TMAP starts from TMAP general information (TMAP_GI), TMAPI search pointers (TMAPI_SRP) and TMAP information (TMAPI) follow, and ends with ILVU information (ILVUI).

<About Playlist File>

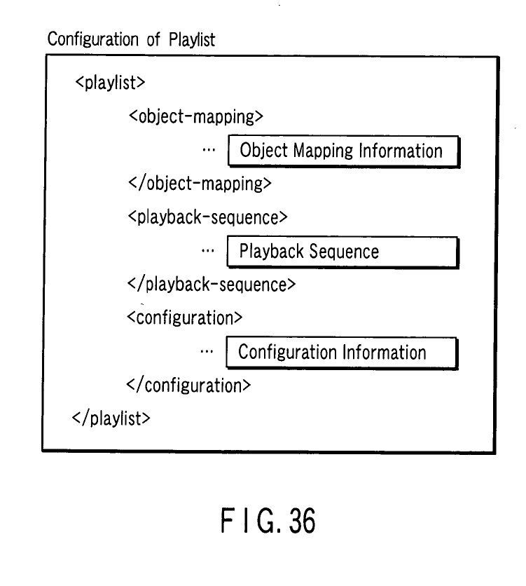

The playlist file can describe information of an initial system configuration for an HD-DVD player, and a title for the advanced content. As shown in, e.g., FIG. 36, a set of object mapping information and a playback sequence for each title are described for each title. This playlist file is encoded in an XML format. The syntax of the playlist file can be defined by the XML syntax representation.

This playlist file controls to play back a menu and title including a plurality of objects based on the time map used to play back these objects during designated periods on the timeline. With this playlist, dynamic menu playback can be attained.

A menu which does not link the time map can only inform the user of static information alone. For example, a plurality of thumbnails that represent chapters which form one title are often attached onto the menu. For example, when the user selects a desired thumbnail via the menu, playback of a chapter to which the selected thumbnail belongs starts. Thumbnails of chapters which form one title including many similar scenes unwantedly present similar video pictures. For this reason, it is difficult to select a desired chapter from a plurality of thumbnails displayed on the menu.

However, a menu which links the time map can inform the user of dynamic information. For example, the menu which links the time map display reduced-scale playback windows (moving pictures) of respective chapters which form one title. In this way, the user can relatively easily discriminate chapters which form one title including similar scenes. That is, the menu that links the time map allows diversified display, and can implement complicated menu display with an impact.

<Elements and Attributes>

A Play list element is a root element of that playlist. The XML syntax representation of the Play list element is, for example, as follows:

<Play list>
Configuration TitleSet

</Play list>

The Play list element is configured by a TitleSet element for a set of the information of Titles, and a Configuration element for System Configuration Information. The Configuration element is configured by a set of System Configuration for Advanced Content. The System Configuration Information can be configured by Data Cache configuration that designates, e.g., a streaming buffer size and the like.

The TitleSet element describes information of a set of Titles for Advanced Content. The XML syntax representation of the TitleSet element is, for example, as follows:

<TitleSet>

Title *

</TitleSet>

The TitleSet element is configured by a list of Title elements. The Title number for advanced navigation is serially assigned in turn from “1” in accordance with the document order of Title elements. The Title element is configured to describe information of each title.

That is, the Title element describes information of a Title for Advanced Content configured to include object mapping information and a playback sequence in that title. The XML syntax representation of the Title element is, for example, as follows:

<Title

id = ID
hidden = (true | false)
onExit = positiveInteger>

Primary Video Track?
SecondaryVideoTrack ?
ComplementaryAudioTrack ?
ComplementarySubtitleTrack ?
ApplicationTrack *
Chapter List ?

</Title>

The content of the Title element includes an element fragment for tracks and Chapter List element. Note that the element fragment for tracks is configured by a list of elements of Primary Video Track, Secondary Video Track, SubstituteAudio Track, Complementary Subtitle Track, and Application Track.

Object Mapping Information for a Title is described by the element fragment for tracks. Mapping of a presentation object on the title timeline is described by corresponding elements. Note that the primary video set corresponds to the Primary Video Track, the secondary video set corresponds to Secondary Video Track, the substitute audio corresponds to the SubstituteAudio Track, and the complementary subtitle corresponds to Complementary Subtitle Track. Also, ADV_APP corresponds to the Application Track.

Note that the title timeline is assigned to each title. Information of a Playback Sequence for a Title including chapter points is described by a Chapter List element.

Note that (a) a hidden attribute can describe whether or not a title can be navigated by user operations. If its value is “true”, that title cannot be navigated by user operations. This value can be omitted, and a default value in this case is “false”.

Also note that, (b) an Exit attribute can describe a title to be played back after the current title playback. If the current title playback is located before the end of that title, the player can be configured not to jump (playback).

A Primary Video Track element is used to describe object mapping information of the primary video set in a title. The XML syntax representation of the Primary Video Track element is, for example, as follows:

<Primary Video Track

id = ID>

(Clip | Clip Block) +

</Primary Video Track>

The content of the Primary Video Track element is configured by a list of Clip elements each of which refers to a P-EVOB in a primary video as a presentation object, and a Clip Block element. The player is configured to pre-assign P-EVOBs on the title timeline using start and end times in accordance with the description of Clip elements. Note that the P-EVOBs assigned on the title timeline do not overlap each other.

A Secondary Video Track element describes object mapping information of the secondary video set in a title. The XML syntax representation of the Secondary Video Track element is, for example, as follows:

<SecondaryVideoTrack

id = ID
sync = (true | false)>

Clip +

</SecondaryVideoTrack>

The content of the Secondary Video Track element is configured by a list of Clip elements each of which refers to an S-EVOB in the secondary video set as a presentation object. The player is configured to pre-assign S-EVOBs on the title timeline using start and end times in accordance with the description of Clip elements.

The player is configured to map the Clip and Clip Block on the title timeline using the start and end positions on the title timeline based on title Begin Time and title End Time attributes of the Clip element. Note that the S-EVOBs assigned on the title timeline do not overlap each other.

If a sync attribute is ‘true’, the secondary video set is synchronized with the time on the title timeline. On the other hand, if the sync attribute is ‘false’, the secondary video set can be configured to run based on its own time (in other words, if the sync attribute is ‘false’, playback progresses based on the time assigned to the secondary video set itself in place of that of the title timeline).

Furthermore, if a sync attribute value is ‘true’ or omitted, a presentation object in the secondary video set is a synchronized object. On the other hand, if the sync attribute value is ‘false’, a presentation object in the secondary video set is a non-synchronized object.

The SubstituteAudio Track describes object mapping information of the SubstituteAudio Track and assignment to an Audio Stream Number in that title. The XML syntax representation of the SubstituteAudio Track element is, for example, as follows.

<ComplementaryAudioTrack

id = ID
streamNumber = Number

languageCode = token
>

Clip +

</ComplementaryAudioTrack>

The content of the SubstituteAudio Track element is configured by a list of Clip elements each of which refers to SubstituteAudio as a presentation element. The player is configured to pre-assign SubstituteAudios on the title timeline in accordance with the description of the Clip elements. Note that the SubstituteAudios assigned on the title timeline do not overlap each other.

A specified Audio Stream Number is assigned to each SubstituteAudio. If an Audio_stream_Change API selects a specific stream number of a SubstituteAudio, the player is configured to select the SubstituteAudio in place of an audio stream in the primary video set.

A stream Number attribute describes an audio stream number for this SubstituteAudio.

A language Code attribute describes a specific code and specific code extension for this SubstituteAudio.

A language code attribute value follows the following scheme (BNF scheme). That is, the specific code and specific code extension respectively describe a specific code and specific code extension, e.g., as follows:

languageCode := specificCode ‘:’

specificCodeExtension

specificCode := [A-Za-z] [A-Za-z0-9]

specificCodeExt := [0-9A-F] [0-9A-F]

A Complementary Subtitle Track element describes object mapping information of a complementary subtitle and assignment to a Sub-picture Stream Number in that title. The XML syntax representation of the Complementary Subtitle Track element is, for example, as follows:

<ComplementarySubtitleTrack

id = ID
streamNumber = Number

languageCode = token
>

Clip +

</ComplementarySubtitleTrack>

The content of the Complementary Subtitle Track element is configured by a list of Clip elements, each of which refers to a Complementary Subtitle as a presentation element. The player is configured to pre-assign Complementary Subtitles on the title timeline according to the description of the Clip elements. The Complementary Subtitles assigned on the title timeline do not overlap each other.

The Complementary Subtitle is assigned a specified Sub-picture Stream Number. The player is configured to select a Complementary Subtitle in place of the sub-picture stream if a Sub-picture_stream_Change API selects the stream number of a sub-picture stream in the primary video set.

A stream Number attribute describes a Sub-picture Stream Number for this Complementary Subtitle.

A language code attribute describes a specific code and specific code extension for this Complementary Subtitle.

A language code attribute value follows the following scheme (BNF scheme). That is, the specific code and specific code extension respectively describe a specific code and specific code extension, e.g., as follows:

languageCode := specificCode ‘:’

specificCodeExtension

specificCode := [A-Za-z] [A-Za-z0-9]

specificCodeExt := [0-9A-F] [0-9A-F]

An Application Track element describes object mapping information in an ADV_APP in that title. The XML syntax representation of the Application Track element is, for example, as follows:

<ApplicationTrack

id = ID
loading_info = anyURI
sync = (true | false)
language = string />

Note that the ADV_APP is scheduled on the entire title timeline. When the player starts title playback, it launches the ADV_APP according to a loading information file designated by a loading information attribute. If the player exits title playback, it also terminates the ADV_APP in the title.

The ADV_APP is configured to be synchronized with the time on the title timeline if a sync attribute is ‘true’. On the other hand, the ADV_APP can be configured to run based on its own time if the sync attribute is ‘false’.

A loading information attribute describes the URI for a loading information file that describes initialization information of the application.

If the value of the sync attribute is ‘true’, it indicates that the ADV_APP in the Application Track is a synchronized object. On the other hand, if the sync attribute value is ‘false’, it indicates that the ADV_APP in the Application Track is a non-synchronized object.

The Clip element describes information of a period (a life period or a period from the start time to the end time) of a presentation object on the title timeline. The XML syntax representation of the Clip element is, for example, as follows:

<Clip

id = ID
title Time Begin = time Expression
clip Time Begin = time Expression
title Time End = time Expression
src = anyURI
preload = time Expression
xml:base = anyURI >

(Unavailable Audio Stream | Unavailable

Sub picture Stream )*

</Clip>

The life period of a presentation object on the title timeline is determined by the start and end times on the title timeline. The start and end times on the title timeline can be respectively described by a title Time Begin attribute and title Time End attribute. The starting position of the presentation object is described by a clip Time Begin attribute. At the start time on the title timeline, the presentation object exists at the start position described by the clip Time Begin attribute.

A presentation object is referred to by the URI of an index information file. For the primary video set, a TMAP file for a P-EVOB is referred to. For the secondary video set, a TMAP file for an S-EVOB is referred to. For the substitute audio and complementary subtitle, a TMAP file for an S-EVOB of the secondary object set including each object is referred to.

The attribute values of title Begin Time, title End Time, clip Begin Time, and the duration time of a presentation object are configured to satisfy the following relations:

title Begin Time<title End Time, and

clip Begin Time+title End Time−title Begin Time≦duration time of Presentation Object

An Unavailable Audio Stream and Unavailable Sub picture Stream exist only for a Clip element in a Preliminary Video Track element.

The title Time Begin attribute describes the start time of a continuous fragment of a presentation object on the title timeline.

The title Time End attribute describes the end time of the continuous fragment of a presentation object on the title timeline.

The clip Time Begin attribute describes the starting position in a presentation object, and its value can be described in a time Expression value. Note that the clip Time Begin attribute can be omitted. If no clip Time Begin attribute is described, the starting position is set to be, e.g., ‘0’.

An src attribute describes the URI of an index information file of a presentation object to be referred to.

A preload attribute can describe the time on the title timeline upon starting playback of a presentation object prefetched by the player.

The Clip Block element describes a group of Clips in a P-EVOBS, which is called a Clip Block. One Clip is selected for playback. The XML syntax representation of the Clip Block element is, for example, as follows:

<Clip Block>

Clip+

</Clip Block>

All Clips in the Clip Block are configured to have the same start time and the same end time. Hence, the clip block can be scheduled on the title timeline using the start and end times of the first child Clip. Note that the Clip Block can be used in only the Primary Video Track.

The Clip Block can represent an Angle Block. The Angle number for advanced navigation is serially assigned in turn from ‘1’ in accordance with the document order of Clip elements.

The player selects the first Clip as a default to be played back. If an Angle_Change API selects a specified Angle number, the player selects a Clip corresponding to that number as an object to be played back.

The Unavailable Audio Stream element in the Clip element which describes a Decoding Audio Stream in a P-EVOBS is configured to be unavailable during the playback period of the corresponding Clip. The XML syntax representation of the Unavailable Audio Stream element is, for example, as follows:

<Unavailable Audio Stream

number = integer
/>

The Unavailable Audio Stream element can be used only in the Clip element for a P-EVOB in the Primary Video Track element. Otherwise, the Unavailable Audio Stream element is configured to be absent. The player disables the Decoding Audio Stream designated by a number attribute.

The Unavailable Sub picture Stream element in the Clip element that describes a Decoding Sub-picture Stream in a P-EVOBS is configured to be unavailable during the playback period of that Clip. The XML syntax representation of the Unavailable Sub picture Stream element is, for example, as follows:

<Unavailable Sub picture Stream

number = integer
/>

The Unavailable Sub picture Stream element can be used only in the Clip element for a P-EVOB in the Primary Video Track element. Otherwise, the Unavailable Sub picture Stream element is configured to be absent. The player disables the Decoding Sub-picture Stream designated by a number attribute.

The Chapter List element in the Title element describes playback sequence information for the corresponding title. Note that the playback sequence defines a chapter start position using a time value on the title timeline. The XML syntax representation of the Chapter List element is, for example, as follows:

<Chapter List>

Chapter+

</Chapter List>

The Chapter List element is configured by a list of Chapter elements. Each Chapter element describes the chapter start position on the title timeline. A chapter number for advanced navigation is serially assigned in turn from ‘1’ in accordance with the document order of Chapter elements in the Chapter List. That is, the chapter start positions in the title timeline are configured to monotonically increase in correspondence with the chapter numbers.

The Chapter element describes the chapter start position on the title timeline in the playback sequence. The XML syntax representation of the Chapter element is, for example, as follows:

<Chapter

id = ID
title Begin Time = time Expression />

The Chapter element has a title Begin Time attribute. A time Expression value of this title Begin Time attribute describes the chapter start position on the title timeline.

The title Begin Time attribute describes the chapter start position on the title timeline in the playback sequence, and its value is described in a time Expression value.

<Datatypes>

“time Expression” describes a time code using a positive integer in, e.g., a 90-kHz unit.

[About Loading Information File]

The loading information file is initialization information of an ADV_APP for a title, and the player is configured to launch the ADV_APP in accordance with information in the loading information file. This ADV_APP has a configuration including presentation of Markup files and enhancement of a Script.

The initialization information described in the loading information file includes:
files to be stored in the file cache before execution of an initial markup file;
the initial markup file to be executed; and
a script file to be executed.

The loading information file is encoded in a correct XML format, and rules for an XML document file apply to it.

<Elements and Attributes>

The syntax of the loading information file is specified by the XML syntax representation.

An Application element is a root element of the loading information file, and includes the following elements and attributes.

The XML syntax representation of the Application element is as follows:

<Application

Id = ID
>

Resource* Script ? Markup ? Boundary ?

</Application>

A Resource element describes files to be stored in the file cache before execution of the initial markup file, and the XML syntax representation of the Resource element is as follows:

<Resource

id = ID
src = anyURI
/>

Note that an src attribute describes the URI of a file to be stored in the file cache.

A Script element describes an initial Script file for the ADV_APP, and the XML syntax representation of the Script element is as follows:

<Script

id = ID
src = anyURI
/>

Upon application startup, a script engine loads a script file to be referred to by the URI in an src attribute, and executes the loaded file as a global code ([ECMA 10.2.10]). Note that the src attribute describes the URI for an initial script file.

A Markup element describes an initial markup file for the ADV_APP, and the XML syntax representation of the Markup element is as follows:

<Markup

id = ID
src = anyURI
/>

Upon application startup, the advanced navigation is configured to load a markup file by referring to the URI in an src attribute after execution of the initial script file if an initial script file exists. Note that the src attribute describes the URI for an initial markup file.

A Boundary element is configured to describe an effective URL that the application can refer to.

<About Markup File>

A markup file is information of a presentation object on the Graphics Plane. The number of markup files that can simultaneously exist in the application is limited to one. The markup file is configured by a content model, styling, and timing.

<About Script File>

A script file describes a Script global code. The script engine is configured to execute a script file upon startup of the ADV_APP, and to wait for an event in an event handler defined by the executed Script global code.

Note that the Script is configured to control the playback sequence and Graphics on the Graphics Plane in accordance with events such as a User Input Event, Player playback event, and the like.

<Playlist File: Described in XML (Markup Language)>

The player is configured to play back the playlist file first (prior to playback of the advanced content) if the disc has the advanced content.

This playlist file can include:
object mapping information (which exists in each title, and is information for a presentation object to be mapped on the timeline of this title);
playback sequence (which is described based on the timeline of a title, and is playback information of each title); and
configuration information (information for the system configuration such as data buffer alignment, etc.).

Note that the primary video set is configured to include video title set information (VTSI), an enhanced video object set for a video title set (VTS_EVOBS), a backup of the video title set information (VTSI_BUP), and video title set time map information (VTS_TMAPI).

Some of the following files can be stored in an archive without compression:
manifest (XML);
markup (XML);
script (ECMAScript);
image (JPEG/PNG/MNG);
effect audio (WAV);
font (OpenType); and
advanced subtitle (XML).

In this standard, a file stored in an archive is called an advanced stream. This file is recorded on the disc (under the ADV_OBJ directory) or can be distributed from the server. This file is multiplexed on an EVOB of the primary video set. In this case, the file is broken up into packs called advanced packs (ADV_PCK).

FIG. 36 is a view for explaining a configuration example of the playlist. “Object mapping”, “playback sequence”, and “configuration” are described in three fields designated under the root element.

This playlist file can include:
object mapping information (which exists in each title, and is information for a presentation object to be mapped on the timeline of this title);
playback sequence (which is described based on the timeline of a title, and is playback information of each title); and
configuration information (information for the system configuration such as data buffer alignment, etc.)

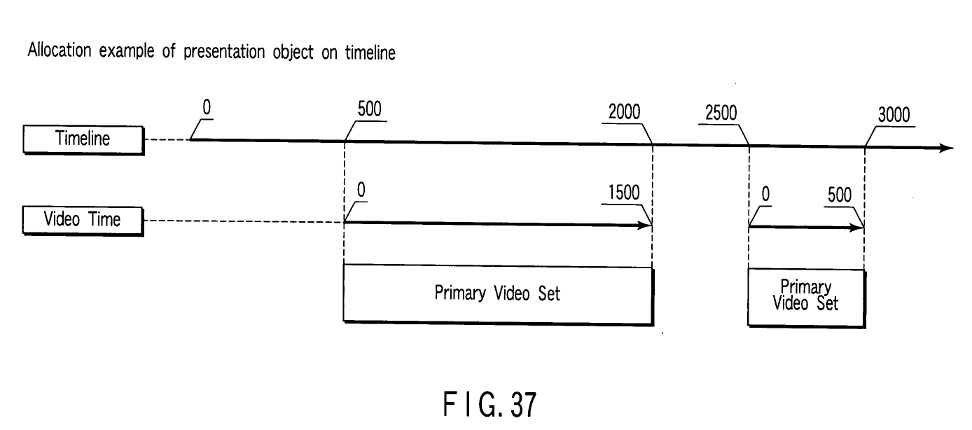

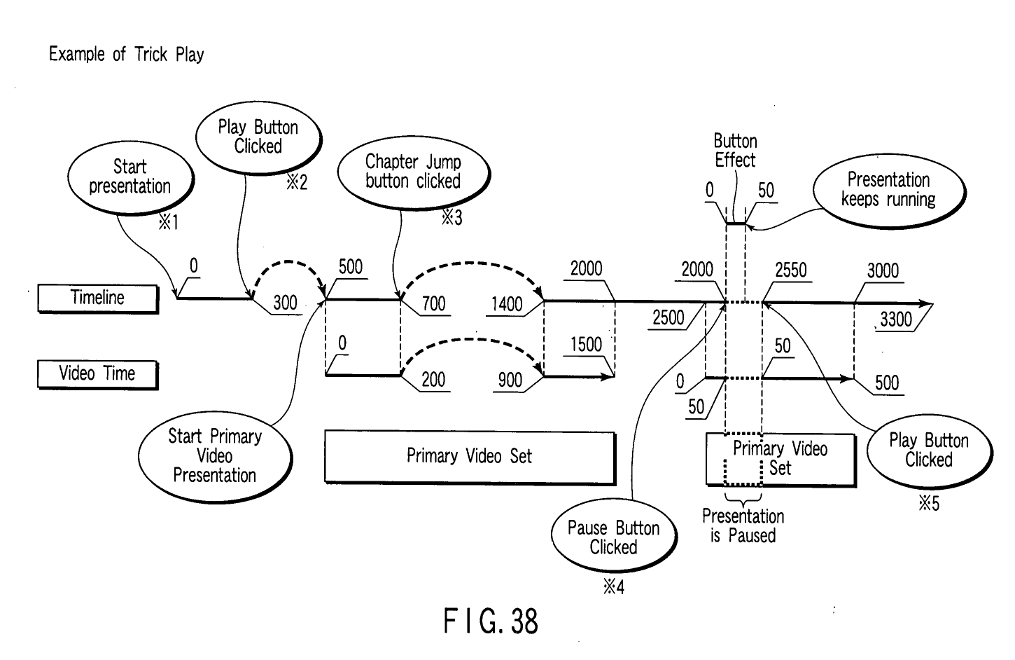

FIGS. 37 and 38 are views for explaining the timeline used in the playlist. FIG. 37 shows an example of allocation of presentation objects on the timeline. Note that the unit of the timeline can use a video frame unit, second (msec) unit, 90-kHz/27-MHz-based clock unit, unit specified by SMPTE, and the like. In the example shown in FIG. 37, two primary video sets having time durations of 1500 and 500, respectively, are prepared, and are allocated on time ranges 500 to 1500 and 2500 to 30 on the timeline as one time axis. By allocating objects respectively having time durations on the timeline as one time axis, respective objects can be played back without any inconsistency. Note that the timeline is configured to be reset to zero for each playlist used.

FIG. 38 is a view for explaining an example upon making trick play (chapter jump or the like) of a presentation object on the timeline. FIG. 38 shows an example of the time progress on the timeline upon actually making a playback operation. That is, when playback starts, the time on the timeline begins to progress (*1). Upon pressing of a Play button at time 300 on the timeline (*2), the time on the timeline jumps to 500 to start playback of a primary video set. After that, upon pressing a Chapter Jump button at time 700 (*3), the playback position jumps to the start position (time 1400 on the timeline in this case) of a corresponding Chapter, and playback starts from there. Upon clicking a Pause button (by the user of the player) at time 2550 (*4), the playback pauses after a button effect. Upon clicking the Play button at time 2550 (*5), the playback restarts.

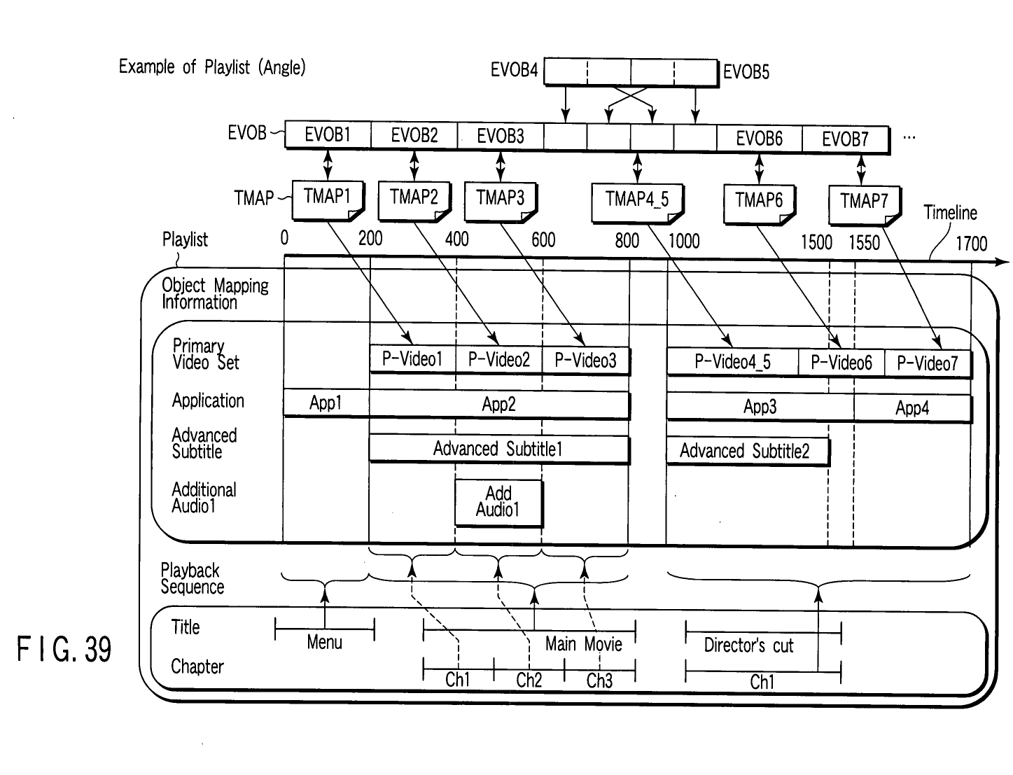

FIG. 39 shows an example of a playlist when EVOBs have interleaved angles. Each EVOB has a corresponding TMAP file. However, information of EVOB4 and EVOB5 as an interleaved angle block is written in one TMAP file. By designating each TMAP file by object mapping information, a primary video set is mapped on the timeline. Applications, advanced subtitles, additional audio, and the like are mapped on the timeline based on the description of object mapping information in the playlist.

In FIG. 39, a title having no video and the like (used as a menu or the like) is defined within the time range from 0 to 200 on the timeline. During the time period from 200 to 800, App2, P-Video (Primary Video) 1 to P-Video3, Advanced Subtitle1, and Add Audio1 are set. During the time period from 1000 to 1700, P-Video4_{—}5 including EVOB4 and EVOB5 which form an angle block, P-Video6, P-Video7, App3, App4, and Advanced Subtitle2 are set.

The playback sequence defines that App1 forms a menu as one title, App2 forms a main movie, and App3 and App4 form a Director's cut. In the main movie, three Chapters are defined. In the Director's cut, one Chapter is defined.

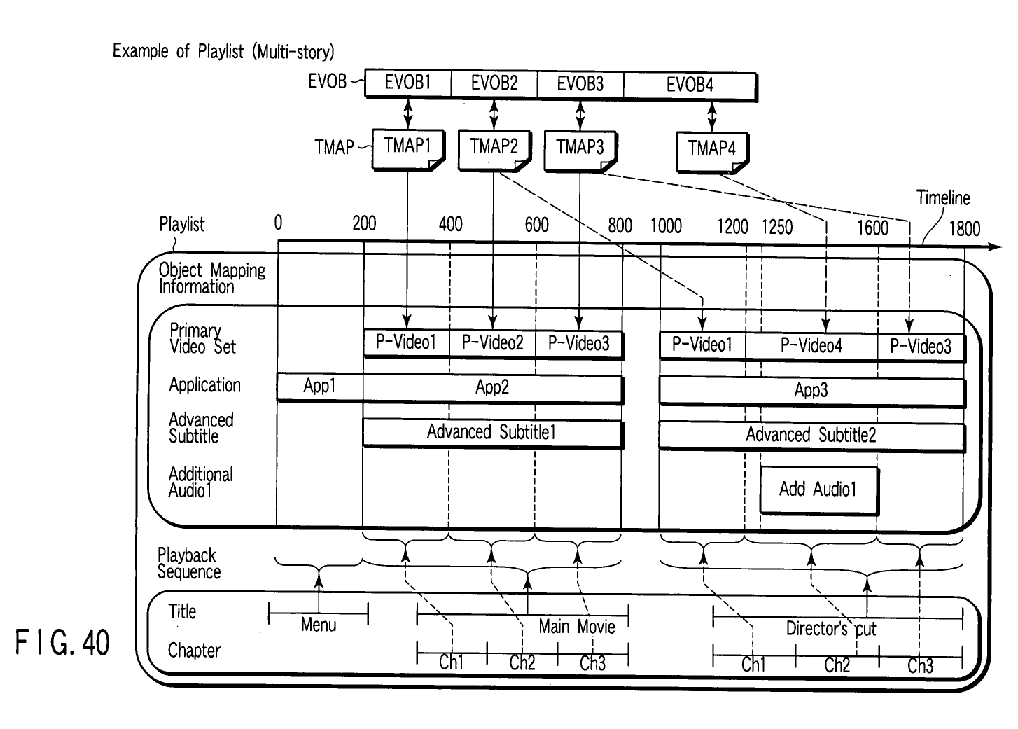

FIG. 40 is a view for explaining a configuration example of a playlist when objects include multi-stories. FIG. 40 shows an image of the playlist upon setting multi-stories. By designating TMAP files in object mapping information, two titles are mapped on the timeline. In this example, EVOB1 and EVOB3 are used in both the titles, and EVOB2 and EVOB4 are replaced, thus allowing multi-stories.

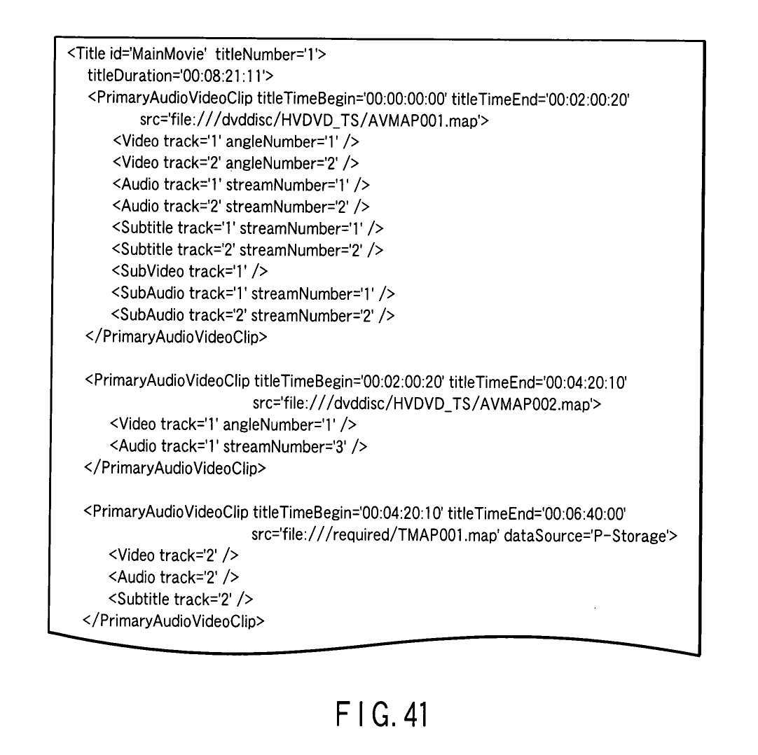

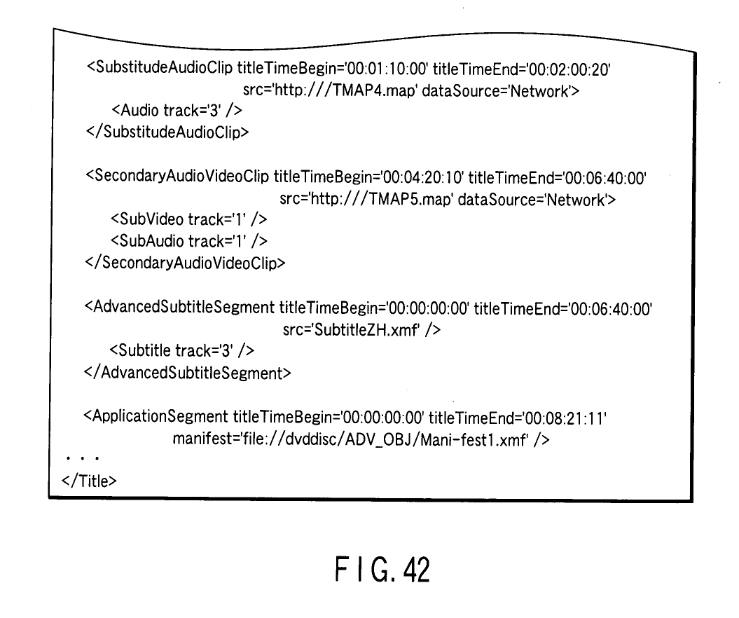

FIGS. 41 and 42 are views for explaining description examples (when objects include angle information) of object mapping information in a playlist. Each track element is used to designate a corresponding object, and the time on the timeline is expressed using start and end attributes.

At this time, when objects are allocated on the timeline without any time gap like App1 and App2 in FIG. 39, an end attribute can be omitted. When a time gap is formed like App2 and App3, their times are expressed using end attributes. Using a name attribute, the current playback status can be displayed on (the display panel of) the player or an external monitor screen. Note that Audio tracks and Subtitle tracks can be identified using Stream numbers.

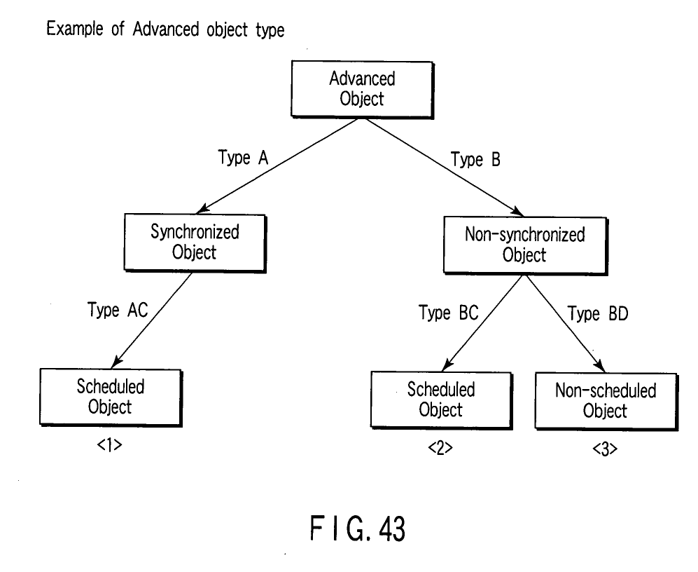

FIG. 43 is a view for explaining examples (four examples in this case) of advanced object types. Advanced objects can be classified into three types shown in FIG. 43: a type in which an object is played back in synchronism with the timeline (<1>), and types in which an object is non-synchronously played back based on its own playback time (<2>, <3>). Then, the objects are classified into a type in which the playback start time on the timeline is recorded in the playlist, and playback starts at that time (scheduled object <2>), and a type in which an object has an arbitrary playback start time in response to, e.g., a user operation (non-scheduled object <3>).

FIG. 44 is a view for explaining an example of the remote controller used together with the player shown in FIG. 19 or the like. This remote controller has a “repeat key” as an example of an operation key other than keys used in playback of HD_DVD-Video, and has “ABCD” button keys K1000 as an example of operation keys used in playback of HD_DVD-Video (these keys are merely examples, and there are various keys corresponding to other operations). When an instruction is issued to use one of “ABCD” button keys K1000, the user presses one of keys K1000 to perform a predetermined operation.

In HD_DVD-Video, two independent streams (P-EVOB and S-EVOB) can be synchronously played back (see FIG. 26, etc.) If repeat playback of a P-EVOB is instructed during the synchronous playback, the synchronous playback with an S-EVOB may be disturbed. For this reason, this embodiment exemplifies the “repeat key” as an example of an operation key other than the keys used in playback of HD_DVD-Video.

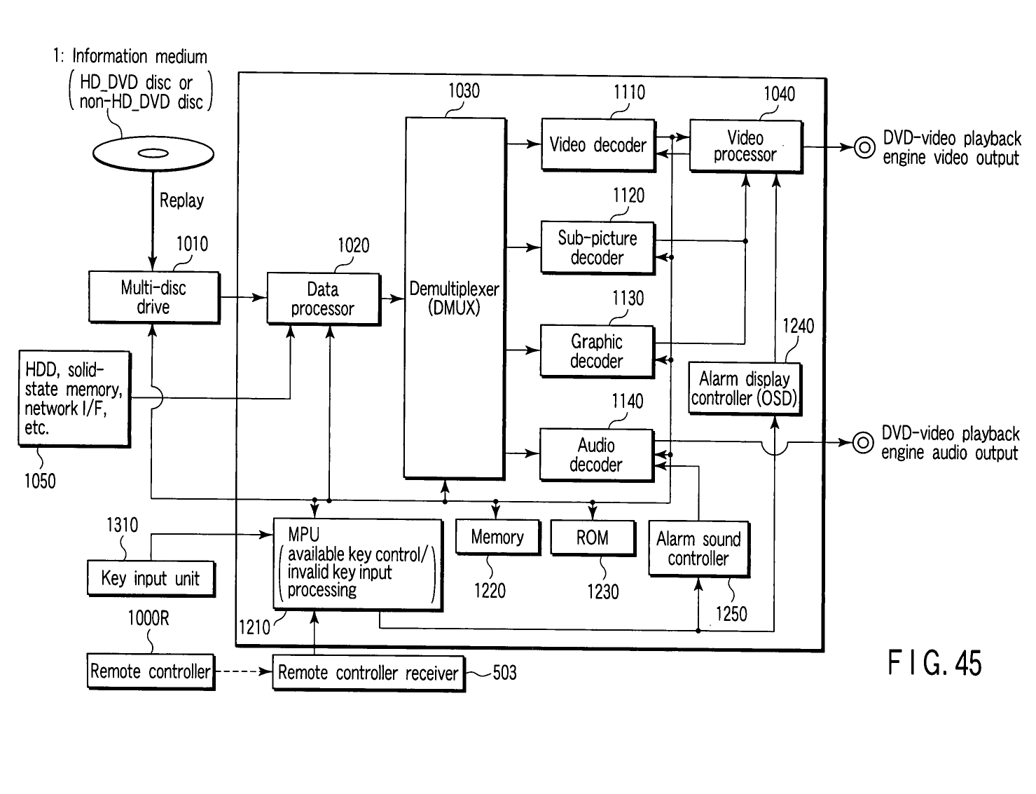

FIG. 45 is a block diagram for explaining an example of the internal structure of a player (a multi-disc player compliant to playback of HD_DVD-Video media and other media) operated by keys on the remote controller shown in FIG. 44. Referring to FIG. 45, information storage medium 1 stores an HD_DVD-Video content according to one embodiment of the invention. Multi-disc drive 1010 that plays back various kinds of optical media plays back the HD_DVD-Video content from this information storage medium 1, and transfers it to data processor 1020. A VOB (Video Object) as video data in the HD_DVD-Video content includes a set of VOBUs (Video Object Units) as a basic unit, and each VOBU has navi pack a3 allocated at its head. Video, audio, and sub-picture data are distributed and allocated in video, audio, and sub-picture (SP) packs to form a multiplexed structure.

One embodiment of the invention newly has graphic unit data, which is distributed and recorded in graphic unit (GU) packs. Demultiplexer 1030 in FIG. 45 demultiplexes the VOB in which various data are multiplexed into packets, and supplies the video data recorded in the video packs to video decoder 1110, the sub-picture data recorded in the sub-picture packs to sub-picture decoder 1120, the graphic unit data recorded in the graphic unit packs to graphic decoder 1130, and the audio data recorded in the audio packs to audio decoder 1140. These data are respectively decoded by decoders 1110 to 1140, and are appropriately mixed in video processor 1040. Then, the mixed data are converted into analog signals by digital-to-analog converters 1320 and 1330, and the analog signals are output.

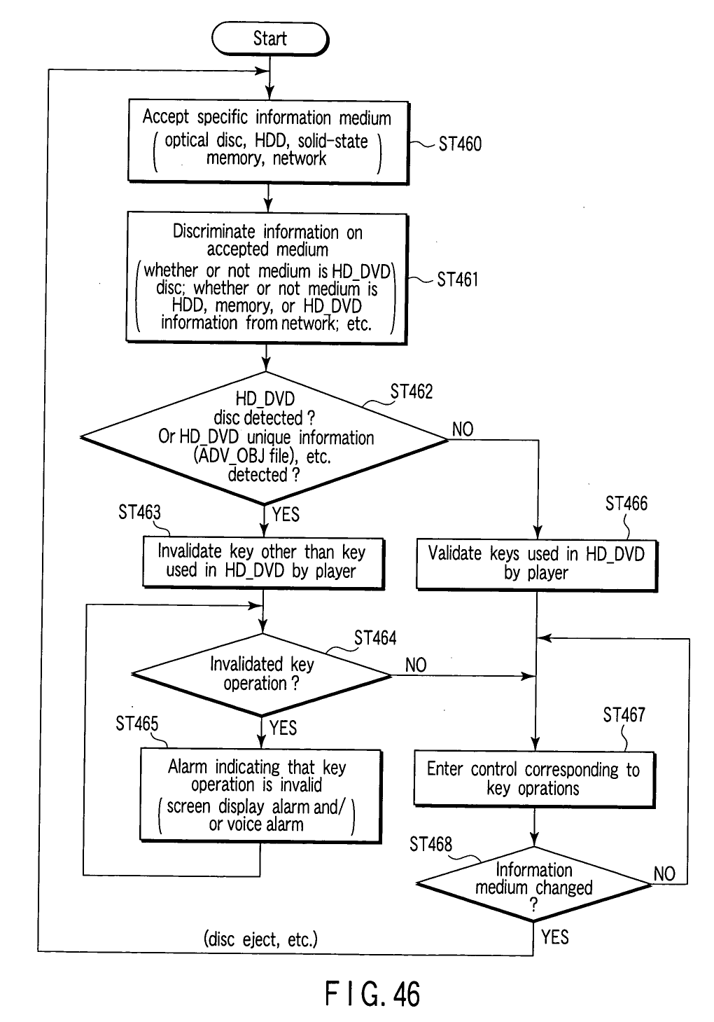

MPU 1210 systematically manages a series of these processes, and temporarily stores data which is to be temporarily stored during processing in memory (work RAM) 1220. Processing programs (processing in FIG. 46, etc.) processed by MPU 1210 and permanent information (including icon data for a user alarm and speech synthesis information) set in advance are recorded in ROM 1230. User operations are made by key inputs from key input unit 1310 (equipped on the front panel in FIG. 19) or those from remote controller 1000R received by remote-controller receiver 503.

If the user has made an inhibited key operation, an alarm icon (and/or alarm message) read out from ROM 1230 is sent to alarm display controller 1240. Then, alarm display controller 1240 sends corresponding alarm data (bitmap data) to video processor 1040. As a result, an alarm message and/or alarm icon or the like are/is displayed on the monitor screen (not shown). Also, alarm sound controller 1250 sends corresponding alarm data (audio data) to audio decoder 1140. Then, an alarm voice (announcement from a speech synthesis ROM, etc.) is output from a loudspeaker (not shown).

FIG. 46 is a flowchart for explaining key control processing (HD_DVD identification processing/processing for invalidating key inputs other than keys used in HD_DVD, etc.) in the player shown in FIG. 45. Upon loading a new disc while the power switch of the player is ON (or upon turning on the power switch while a disc is already loaded on a disc tray (not shown)), the player system shown in FIG. 45 accesses that disc, and accepts it if it is a normal disc (ST460). In this case, if the player in FIG. 45 has a structure for accepting another information medium 1050 such as a hard disc drive (HDD), solid-state memory, network I/F, or the like, that medium 1050 is accepted.

After that, file information and the like are loaded from the accepted information medium to discriminate that medium (ST461). In this way, whether or not the accepted medium is an HD_DVD disc and/or whether or not the accepted medium records information that can specify HD_DVD can be detected.

If it is detected that the accepted information medium is an HD_DVD disc, or if information unique to HD_DVD (e.g., an ADV_OBJ file in FIG. 13) is read out from that medium (YES in ST462), the player in FIG. 45 invalidates keys (e.g., the repeat key and the like of the remote controller shown in FIG. 44) other than keys that the player uses in HD_DVD playback (keys used in disc playback in case of HD_DVD disc playback, or keys used in HDD playback in case of HD_DVD content playback recorded on the HDD or the like) (ST463).

If the user makes a key operation (e.g., a P-EVOB repeat key operation during synchronous playback of P-EVOB and S-EVOB) other than keys used in HD_DVD playback (YES in ST464), an alarm presentation (message or icon) indicating that the key operation is invalid is displayed by, e.g., OSD (on-screen display), and/or a voice alarm like “your operation is inhibited now” is output from the speech synthesis ROM (ST465).

If the user makes a key operation (e.g., normal playback start) used in HD_DVD playback (NO in ST464), the process advances to an operation control routine corresponding to the key operation (ST467).

If it is detected that the accepted information medium is not an HD_DVD disc or if the medium does not record any information (e.g., ADV_OBJ file) unique to HD_DVD (NO in ST462), the player in FIG. 45 validates keys used in playback other than HD_DVD (ST466). In this case, if the user makes a valid key operation (e.g., a repeat key operation), the process advances to an operation control routine corresponding to the key operation (ST467).

If the information medium to be played back currently is not changed (NO in ST468), operation control corresponding to valid key operations at that time is continued (ST467). If the information medium to be played back currently is changed by, e.g., ejecting the disc (YES in ST468), the process returns to ST460.

Note that the medium change in ST468 takes place when an object to be played back is switched from HD_DVD to DVD (or vice versa) upon playback of a single disc that records both an HD_DVD content and conventional DVD content. In this case, the presence/absence of HD_DVD unique information (ADV_OBJ, etc.) is mainly detected in ST462.

The player in FIG. 45 is configured to execute the processing shown in the flowchart of FIG. 46, and plays back recorded information in various modes from a plurality of types of information media including an information medium (HD_DVD disc) recording high-definition video information in response to a plurality of key operations of the remote controller 1000R and the like.

In this player, the medium type (HD_DVD disc, DVD disc, CD, solid-state memory, HDD, Web, etc.) of an information medium to be played back is discriminated as well as detection as to whether or not the information medium to be played back includes information (ADV_OBJ file, etc.) unique to the high-definition video information (ST461).

If the discriminated information medium to be played back is an information medium (HD_DVD disc) that records the high-definition video information, or if the discriminated information medium to be played back includes the information (ADV_OBJ file, etc.) unique to the high-definition video information (YES in ST462), operation keys other than keys used in playback of the information medium (HD_DVD disc) that records the high-definition video information are invalidated (ST463). Further, operation control is made in response to key operations (ABCD key operations in FIG. 44, etc.) other than the invalidated key operations (ST467).

When the operation keys other than keys used in playback of the information medium (HD_DVD disc) that records the high-definition video information are invalidated (ST463), if an invalidated key operation is made (YES in ST464), an alarm indicating that the key operation is invalid is visually and/or audibly generated (ST465).

The information medium (HD_DVD disc) that records the high-definition video information has a file information recording area (11 in FIG. 34) used to manage the recorded contents. This file information recording area records an advanced object file (ADV_OBJ file) unique to the high-definition video information. Upon detection of this advanced object file (ADV_OBJ file), operation keys other than keys used upon playback of the information medium (HD_DVD disc) that records the high-definition video information are invalidated (ST463).

<Summary of Embodiment>

1. An information playback apparatus which allows playback of an HD_DVD disc and at least one disc of a different type has a function of discriminating the type of an inserted disc, and invalidating, only when the HD_DVD disc is discriminated, key inputs other than keys used in HD_DVD.

2. The information playback apparatus which allows playback of an HD_DVD disc and at least one disc of a different type has a function of discriminating the type of an inserted disc, and making, only when the HD_DVD disc is discriminated, an alarm presentation as OSD or the like using an icon or the like.

3. In the HD_DVD disc, in order to suppress, e.g., a repeat function, since the type is specified upon insertion of the disc, pressing of a repeat key is invalidated for only the HD_DVD disc. Upon pressing of the repeat key under the above conditions, user's confusion can be avoided by clearly specifying the invalid key operation using an icon or the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. An information playback apparatus for playing back recorded information from a plurality of types of information media, including an information medium that records high-definition video information, in response to a plurality of key operations, comprising:
a discriminator configured to discriminate a medium type of an information medium to be played back and to detect whether or not the information medium to be played back includes information unique to the high-definition video information;
an invalidator configured to invalidate operation keys other than keys used in playback of the information medium that records the high-definition video information when the discriminated information medium to be played back is an information medium that records the high-definition video information or when the discriminated information medium to be played back includes the information unique to the high-definition video information; and
a controller configured to perform operation control corresponding to a key operation other than the invalidated key operations.

2. The apparatus according to claim 1, further comprising:
an alarm unit configured to generate, when the operation keys other than keys used in playback of the information medium that records the high-definition video information are invalidated and when the invalidated key operation is made, a visual and/or audible alarm or alarms indicating that the key operation is invalid.

3. The apparatus according to claim 1, wherein the information medium that records the high-definition video information includes a file information recording area used to manage recorded contents, the file information recording area records an advanced object file unique to the high-definition video information, and when the advanced object file is detected, the operation keys other than keys used in playback of the information medium that records the high-definition video information are invalidated.

4. An operation key control method for playing back recorded information from a plurality of types of information media, including an information medium that records high-definition video information, in response to a plurality of key operations, comprising:
discriminating a medium type of an information medium to be played back in addition to detection as to whether or not the information medium to be played back includes information unique to the high-definition video information;
invalidating operation keys other than keys used in playback of the information medium that records the high-definition video information when the discriminated information medium to be played back is an information medium that records the high-definition video information or when the discriminated information medium to be played back includes the information unique to the high-definition video information; and
performing operation control corresponding to a key operation other than the invalidated key operations.

5. The method according to claim 4, further comprising: visually and/or audibly generating, when the operation keys other than keys used in playback of the information medium that records the high-definition video information are invalidated and when the invalidated key operation is made, an alarm indicating that the key operation is invalid.

6. The method according to claim 4, wherein the information medium that records the high-definition video information includes a file information recording area used to manage recorded contents, the file information recording area records an advanced object file unique to the high-definition video information, and when the advanced object file is detected, the operation keys other than keys used in playback of the information medium that records the high-definition video information are invalidated.
